(19) United States
(12) Patent Application Publication
(10) Pub. No.: US 2023/0276526 A1
(43) Pub. Date: Aug. 31, 2023

(54) METHOD AND DEVICE FOR SUPPORTING SIDELINK DISCONTINUOUS RECEPTION IN WIRELESS COMMUNICATION SYSTEM

(71) Applicant: Samsung Electronics Co., Ltd., Suwon-si, Gyeonggi-do (KR)

(72) Inventors: Cheolkyu SHIN, Suwon-si (KR); Hyunseok RYU, Suwon-si (KR); Jeongho YEO, Suwon-si (KR); Youngbum KIM, Suwon-si (KR); Sungjin PARK, Suwon-si (KR); Seunghoon CHOI, Suwon-si (KR)

(21) Appl. No.: 18/007,022

(22) PCT Filed: Jul. 28, 2021
(86) PCT No.: PCT/KR2021/009771

§ 371 Date: Jan. 26, 2023

(30) Foreign Application Priority Data
Jul. 29, 2020 (KR) 10-2020-0094800

(51) Int. Cl. H04W 76/28; H04W 76/23

(52) U.S. Cl. CPC H04W 76/28; H04W 76/23

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services.

### CROSS-REFERENCE TO RELATED APPLICATIONS

This application is a 371 National Stage of International Application No. PCT/KR2021/009771, filed Jul. 28, 2021, which claims priority to Korean Patent Application No. 10-2020-0094800, filed Jul. 29, 2020, the disclosures of which are herein incorporated by reference in their entirety.

### BACKGROUND

### 1. Field

The disclosure relates to a wireless mobile communication system, and more particularly, to a method and device for performing discontinuous reception (hereinafter, DRX) in a process in which a vehicle terminal supporting vehicle-to-everything (hereinafter, V2X) transmits and receives information to and from another vehicle terminal and a pedestrian portable terminal using a sidelink.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

In a communication or broadcast system, a link performance may be significantly degraded by various kinds of noise of a channel, a fading phenomenon, and inter-symbol interference (ISI). Therefore, in order to implement high-speed digital communication or broadcasting systems requiring high data throughput and reliability, such as next-generation mobile communication, digital broadcasting, and portable Internet, it is required to develop a technology for overcoming noise, fading, and inter-symbol interference. As a part of research to overcome noise, and the like, recently, a research on error-correcting codes has been actively conducted as a method of increasing communication reliability by efficiently restoring information distortion.

### SUMMARY

The disclosure relates to a wireless communication system, and more particularly, to a method and device for selecting a transmission resource through inter-terminal cooperation in a process in which a vehicle terminal supporting V2X gives and receives information to and from another vehicle terminal and a pedestrian portable terminal using a sidelink. Specifically, the disclosure relates to a sensing and resource selection method and terminal operation when inter-terminal discontinuous reception (hereinafter, DRX) is performed.

According to an embodiment of the disclosure, a method performed by a terminal in a communication system includes identifying whether a discontinuous reception (DRX) cycle is configured for a sidelink; determining, in the case that a DRX cycle is configured, a ratio of senseable slots in a sensing window; and monitoring, in the case that a ratio of the senseable slots is greater than a predetermined value, at least part of slots included in an activation period of the DRX cycle within the sensing window.

Further, according to an embodiment of the disclosure, a terminal in a communication system includes a transceiver; and a controller connected to the transceiver, and configured to identify whether a discontinuous reception (DRX) cycle is configured for a sidelink, to determine a ratio of senseable slots in a sensing window in the case that a DRX cycle is configured, and to monitor at least part of slots included in an activation period of the DRX cycle within the sensing window in the case that a ratio of the senseable slots is greater than a predetermined value.

The disclosure provides a procedure for performing inter-terminal discontinuous reception (DRX) in sidelink communication. The proposed method can be effectively used for minimizing power consumption of a terminal. Further, through the proposed method, the terminal can perform sensing and resource selection in a DRX operating situation.

### BRIEF DESCRIPTION OF THE DRAWINGS

FIG. 1 is a diagram illustrating a system according to an embodiment of the disclosure.

FIG. 2 is a diagram illustrating a V2X communication method performed through a sidelink according to an embodiment of the disclosure.

FIG. 3 is a diagram illustrating a resource pool defined as a set of resources on a time and frequency used for transmission and reception of a sidelink according to an embodiment of the disclosure.

FIG. 4 is a message flow diagram illustrating a method for a base station to allocate transmission resources in a sidelink according to an embodiment of the disclosure.

FIG. 5 is a message flow diagram illustrating a method in which a terminal directly allocates a transmission resource of a sidelink through sensing in a sidelink according to an embodiment of the disclosure.

FIG. 6 is a diagram illustrating a mapping structure of physical channels mapped to one slot in a sidelink according to an embodiment of the disclosure.

FIG. 7A is a diagram illustrating DRX (hereinafter, DRX) off-duration and on-duration determined according to parameters configured for DRX when discontinuous reception is performed in a sidelink according to an embodiment of the disclosure.

FIG. 7B is a diagram illustrating DRX off-duration and on-duration determined according to parameters configured for DRX when discontinuous reception is performed in a sidelink according to an embodiment of the disclosure.

FIG. 7C is a diagram illustrating DRX off-duration and on-duration determined according to parameters configured for DRX when discontinuous reception is performed in a sidelink according to an embodiment of the disclosure.

FIG. 7D is a diagram illustrating DRX off-duration and on-duration determined according to parameters configured for DRX when discontinuous reception is performed in a sidelink according to an embodiment of the disclosure.

FIG. 8A is a diagram illustrating a sensing and resource selection (Mode2) procedure according to an embodiment of the disclosure.

FIG. 8B is a diagram illustrating a sensing and resource selection (Mode2) procedure according to an embodiment of the disclosure.

FIG. 9A is a diagram illustrating a method 2-1 according to an embodiment of the disclosure.

FIG. 9B is a flowchart illustrating a sensing procedure of the case that full sensing is performed according to a method 2-1 of the disclosure.

FIG. 9C is a flowchart illustrating a sensing procedure of the case that partial sensing is performed according to a method 2-1 of the disclosure.

FIG. 10A is a flowchart illustrating a sensing procedure of the case that full sensing is performed according to a method 2-2 of the disclosure.

FIG. 10B is a flowchart illustrating a sensing procedure of the case that partial sensing is performed according to a method 2-2 of the disclosure.

FIG. 11A is a flowchart illustrating a sensing procedure of the case that full sensing is performed according to a method 2-3 of the disclosure.

FIG. 11B is a flowchart illustrating a sensing procedure of the case that partial sensing is performed according to a method 2-3 of the disclosure.

FIG. 12A is a diagram illustrating a method 2-4 according to an embodiment of the disclosure.

FIG. 12B is a flowchart illustrating a sensing procedure of the case that full sensing is performed according to a method 2-4 of the disclosure.

FIG. 12C is a flowchart illustrating a sensing procedure of the case that partial sensing is performed according to a method 2-4 of the disclosure.

FIG. 13A is a diagram illustrating a method 3 according to an embodiment of the disclosure.

FIG. 13B is a flowchart illustrating a sensing procedure of the case that full sensing is performed according to a method 3 of the disclosure.

FIG. 13C is a flowchart illustrating a sensing procedure of the case that partial sensing is performed according to a method 3 according to an embodiment of the disclosure.

FIG. 14A is a diagram illustrating a method 4-1 according to an embodiment of the disclosure.

FIG. 14B is a flowchart illustrating a resource selection procedure according to a method 4-1 of the disclosure.

FIG. 15A is a diagram illustrating a method 4-2 according to an embodiment of the disclosure.

FIG. 15B is a flowchart illustrating a resource selection procedure according to a method 4-2 of the disclosure.

FIG. 16A is a diagram illustrating a method 5 according to an embodiment of the disclosure.

FIG. 16B is a diagram illustrating a resource selection procedure according to a method 5 of the disclosure.

FIG. 17 is a block diagram illustrating an internal structure of a terminal according to an embodiment of the disclosure.

FIG. 18 is a block diagram illustrating an internal structure of a base station according to an embodiment of the disclosure.

### DETAILED DESCRIPTION

Hereinafter, embodiments of the disclosure will be described in detail with reference to the attached drawings.

In describing embodiments, descriptions of technical contents that are well known in the technical field to which the disclosure pertains and that are not directly related to the disclosure will be omitted. This is to more clearly convey the gist of the disclosure without obscuring the gist of the disclosure by omitting unnecessary description.

For the same reason, some components are exaggerated, omitted, or schematically illustrated in the accompanying drawings. Further, the size of each component does not fully reflect the actual size. In each drawing, the same reference numerals are given to the same or corresponding components.

Advantages and features of the disclosure, and a method of achieving them will become apparent with reference to the embodiments described below in detail in conjunction with the accompanying drawings. However, the disclosure is not limited to the embodiments disclosed below, but may be implemented in various different forms, and only these embodiments enable the disclosure to be complete, and are provided to fully inform the scope of the disclosure to those of ordinary skill in the art to which the disclosure pertains, and the disclosure is only defined by the scope of the claims. Like reference numerals refer to like components throughout the specification.

In this case, it will be understood that each block of message flow diagrams and combinations of the message flow diagrams may be performed by computer program instructions. Because these computer program instructions may be mounted in a processor of a general purpose computer, special purpose computer, or other programmable data processing equipment, the instructions performed by a processor of a computer or other programmable data processing equipment generate a means that performs functions described in the message flow diagram block(s). Because these computer program instructions may be stored in a computer usable or computer readable memory that may direct a computer or other programmable data processing equipment in order to implement a function in a particular manner, the instructions stored in the computer usable or computer readable memory may produce a production article containing instruction means for performing the function described in the message flow diagram block(s). Because the computer program instructions may be mounted on a computer or other programmable data processing equipment, a series of operational steps are performed on the computer or other programmable data processing equipment to generate a computer-executed process; thus, instructions for performing a computer or other programmable data processing equipment may provide steps for performing functions described in the message flow diagram block(s).

Further, each block may represent a module, a segment, or a portion of a code including one or more executable instructions for executing a specified logical function(s). Further, it should be noted that in some alternative implementations, functions recited in the blocks may occur out of order. For example, two blocks illustrated one after another may in fact be performed substantially simultaneously, or the blocks may be sometimes performed in the reverse order according to the corresponding function.

In this case, the term ‘-unit’ used in this embodiment means software or hardware components such as a field programmable gate array (FPGA) or an application specific integrated circuit (ASIC), and ‘-unit’ performs certain roles. However, ‘-unit’ is not limited to software or hardware. ‘-unit’ may be formed to reside in an addressable storage medium or may be formed to reproduce one or more processors. Therefore, as an example, ‘-unit’ includes components such as software components, object-oriented software components, class components, and task components, processes, functions, properties, procedures, subroutines, segments of program code, drivers, firmware, microcode, circuit, data, databases, data structures, tables, arrays, and variables. Functions provided in the components and ‘-units’ may be combined into a smaller number of components and ‘-units’ or may be further separated into additional components and ‘-units’. Further, components and ‘-units’ may be implemented to reproduce one or more CPUs in a device or secure multimedia card. Further, in an embodiment, ‘-unit’ may include one or more processors.

In describing the embodiments of the disclosure in detail, a radio access network new RAN (NR) on a 5G mobile communication standard and a packet core (5G system, 5G core network, or next generation core (NG core)), which is a core network in which 3rd generation partnership project long term evolution (3GPP), which is a mobile communication standard standardization organization discloses are main targets, but the main gist of the disclosure may be applied even to other communication systems having a similar technical background with some modifications in a range that does not significantly depart from the scope of the disclosure, which will be possible by determination of a person skilled in the art of the disclosure.

In a 5G system, in order to support network automation, a network data collection and analysis function (NWDAF), which is a network function that provides a function of analyzing and providing data collected from a 5G network, may be defined. The NWDAF may collect/store/analyze information from the 5G network and provide the result to an unspecified network function (NF), and the analysis result may be used independently in each NF.

Hereinafter, for convenience of description, some terms and names defined in the 3GPP standard (standards of 5G, NR, LTE, or similar systems) may be used. However, the disclosure is not limited by terms and names, and may be equally applied to systems conforming to other standards.

Further, a term for identifying an access node used in the following description, a term indicating a network entity, a term indicating messages, a term indicating an interface between network objects, and terms indicating various types of identification information are exemplified for convenience of description. Accordingly, the disclosure is not limited to the terms described below, and other terms indicating objects having equivalent technical meanings may be used.

In order to satisfy increases in demand for wireless data traffic now that a 4G communication system is commercially available, efforts are being made to develop an enhanced 5G communication system (new radio (NR)). In order to achieve a high data rate, the 5G communication system has been designed to enable resources in a mmWave band (e.g., 28 GHz frequency band). In order to mitigate any route loss of electronic waves in a mmWave band and to increase transmission distances of electronic waves, the technologies of beamforming, massive multiple input and multiple output (MIMO), full dimensional MIMO (FD-MIMO), array antenna, analog beamforming, and large scale antenna are being discussed for the 5G communication system. Further, unlike LTE, the 5G communication system supports various subcarrier spacings such as 15 kHz, 30 kHz, 60 kHz, and 120 kHz, a physical control channel uses polar coding, and a physical data channel uses low density parity check (LDPC). Further, CP-OFDM as well as DFT-S-OFDM is used as a waveform for uplink transmission. In LTE, hybrid ARQ (HARQ) retransmission in units of transport block (TB) is supported, whereas 5G may additionally support code block group (CBG)-based HARQ retransmission in which a plurality of code blocks (CBs) are bundled.

Further, in order to enhance networks in the 5G communication system, the technologies of an innovative small cell, advanced small cell, cloud radio access network (cloud RAN), ultra-dense network, device to device communication (D2D), wireless backhaul, vehicle to everything (V2X) network, cooperative communication, coordinated multi-points (CoMP), and interference cancellation are being developed.

Innovation of Internet from a human-centered connection network in which a human generates and consumes information to an Internet of Things (IoT) network that gives and receives and processes information to and from distributed components such as things has occurred. Internet of everything (IoE) technology in which big data processing technology through connection to a cloud server is combined with IoT technology has been appeared. In order to implement the IoT, technology elements such as sensing technology, wired and wireless communication and network infrastructure, service interface technology, and security technology are required; thus, nowadays, research is being carried out on technology of a sensor network, machine to machine (M2M), and machine type communication (MTC) for connection between things. In an IoT environment, an intelligent Internet technology (IT) service that collects and analyzes data generated in connected things to provide a new value to human lives may be provided. The IoT may be applied to the field of a smart home, smart building, smart city, smart car or connected car, smart grid, health care, smart home appliances, and high-tech medical service through fusion and complex connections between existing information technology (IT) and various industries.

Accordingly, various attempts are being made to apply a 5G communication system to an IoT network. For example, technologies such as a sensor network, machine to machine (M2M), and machine type communication (MTC) are being implemented by techniques such as beamforming, MIMO, and array antenna, which are 5G communication technologies. It may be regarded that application of a cloud radio access network (cloud RAN) as the above-described big data processing technology is an example of convergence of 5G technology and IoT technology. In this way, a plurality of services may be provided to a user in a communication system, and in order to provide such a plurality of services to the user, a method and a device using the same are required to provide each service within the same time period according to the characteristics. Various services provided in the 5G communication system are being studied, and one of them is a service satisfying requirements of low latency and high reliability.

In the case of vehicle communication, in an NR V2X system, unicast communication, groupcast (or multicast) communication, and broadcast communication between a terminal and a terminal are supported. Further, NR V2X aims to provide more advanced services such as platooning, advanced driving, extended sensor, and remote driving, unlike LTE V2X, which aims to transmit and receive basic safety information necessary for vehicle road driving.

In particular, inter-terminal discontinuous reception (DRX) may be considered in sidelink communication. In the case that DRX is applied, battery efficiency may be increased by minimizing power consumption of a terminal. Specifically, power consumed in a reception process of the terminal in a sidelink may be subdivided as follows.
Decoding of control information 1st sidelink control information (SCI) transmitted through a PSCCH: the 1st SCI includes scheduling information of the terminal; thus, the corresponding information may be used for sensing by decoding the 1st SCI
Decoding of control information 2nd SCI transmitted through a PSSCH: the 2nd SCI includes other control information that is not included in the 1st SCI
Decoding of data transmitted through a PSSCH

Therefore, the UE may not perform decoding on the control information and data information in a time period configured to off-duration by applying DRX in a sidelink. Alternatively, the terminal may perform decoding on the control information and data information only in a time period configured to on-duration by applying DRX. The disclosure describes methods of defining DRX off-duration and on-duration (active time) in a sidelink. Further, methods of matching wake-up time points between terminals performing communication in a sidelink so that the terminal may receive control information and data information in DRX are introduced. Further, a method of performing sensing and resource selection in a situation in which the terminal operates in DRX is proposed.

Embodiments of this specification are proposed to support the above-described scenario, particularly, provide a method and device for performing inter-terminal discontinuous reception (DRX) in a sidelink.

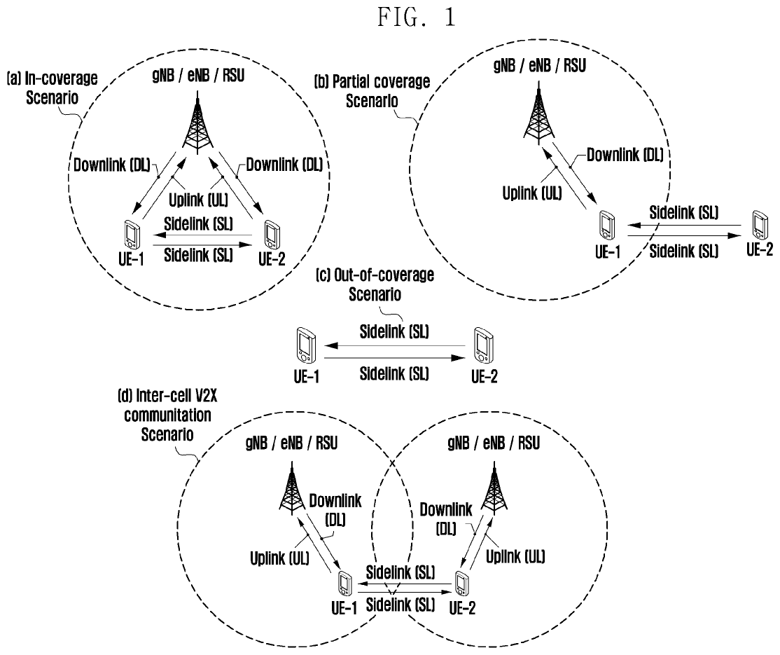

FIG. 1 is a diagram illustrating a system according to an embodiment of the disclosure.

With reference to FIG. 1, FIG. 1A illustrates the case (In-Coverage, IC) that all V2X UE-1 and UE-2 are positioned inside coverage of a base station. All V2X UE-1 and UE-2 may receive data and control information from the base station through a downlink (DL) or transmit data and control information through an uplink (UL) to the base station. In this case, the data and control information may be data and control information for V2X communication. The data and control information may be data and control information for general cellular communication. Further, the V2X UE-1 and UE-2 may transmit and receive data and control information for V2X communication through a sidelink (SL).

With reference to FIG. 1, FIG. 1B illustrates the case that a UE-1 among the UE-1 and UE-2 is positioned inside coverage of the base station and that a UE-2 among the UE-1 and UE-2 is positioned outside coverage of the base station. That is, FIG. 1B illustrates an example of partial coverage (PC) in which a V2X UE-2 is positioned outside coverage of the base station. The V2X UE-1 positioned inside coverage of the base station may receive data and control information from the base station through a downlink or transmit data and control information to the base station through an uplink. The V2X UE-2 positioned outside coverage of the base station cannot receive data and control information from the base station through a downlink, and cannot transmit data and control information to the base station through an uplink. The V2X UE-2 may transmit and receive data and control information for V2X communication to and from the V2X UE-1 through a sidelink.

With reference to FIG. 1, FIG. 1C illustrates the case that the V2X UE-1 and UE-2 are positioned outside coverage (out-of coverage (OOC)) of the base station. Therefore, the V2X UE-1 and UE-2 cannot receive data and control information from the base station through a downlink, and cannot transmit data and control information to the base station through an uplink. The V2X UE-1 and UE-2 may transmit and receive data and control information for V2X communication through a sidelink.

With reference to FIG. 1, FIG. 1D illustrates an example of a scenario of performing V2X communication between the V2X UE-1 and UE-2 positioned in different cells. Specifically, FIG. 1D illustrates the case that the V2X UE-1 and UE-2 are accessed (RRC connection state) or are camping (RRC connection release state, i.e., RRC idle state) in different base stations (RRC connection state). In this case, the V2X UE-1 may be a V2X transmitting UE, and the V2X UE-2 may be a V2X receiving UE. Alternatively, the V2X UE-1 may be a V2X receiving UE, and the V2X UE-2 may be a V2X transmitting UE. The V2X UE-1 may receive a system information block (SIB) from a base station to which it is accessed (or in which it is camping), and the V2X UE-2 may receive a SIB from another base station to which it is accessed (in which it is camping). In this case, as a SIB, an existing SIB may be used or a SIB defined separately for V2X may be used. Further, information on an SIB received by the V2X UE-1 and information on an SIB received by the V2X UE-2 may be different from each other. Therefore, in order to perform V2X communication between the UE-1 and the UE-2 positioned in different cells, a method of interpreting SIB information transmitted from each different cell by unifying information or by signaling information on this may be additionally required.

In FIG. 1, for convenience of description, a V2X system composed of the V2X UE-1 and UE-2 is illustrated, but the disclosure is not limited thereto and communication may be made between more V2X UEs. Further, an interface (uplink and downlink) between the base station and the V2X UEs may be referred to as a Uu interface, and a sidelink between the V2X UEs may be referred to as a PC5 interface. Therefore, in the disclosure, these may be used interchangeably. In the disclosure, the UE may include a vehicle supporting vehicle-to-vehicle communication (V2V), a vehicle or pedestrian handset (e.g., smartphone) supporting vehicle-to-pedestrian communication (V2P), a vehicle supporting vehicle-to-network communication (V2N), or a vehicle supporting vehicle-to-infrastructure communication (V2I). Further, in the disclosure, the UE may include a road side unit (RSU) equipped with a UE function, an RSU equipped with a base station function, or an RSU equipped with a part of the base station function and a part of a UE function.

Further, according to an embodiment of the disclosure, the base station may be a base station supporting both V2X communication and general cellular communication, or a base station supporting only V2X communication. In this case, the base station may be a 5G base station (gNB), a 4G base station (eNB), or an RSU. Accordingly, in the disclosure, the base station may be referred to as an RSU.

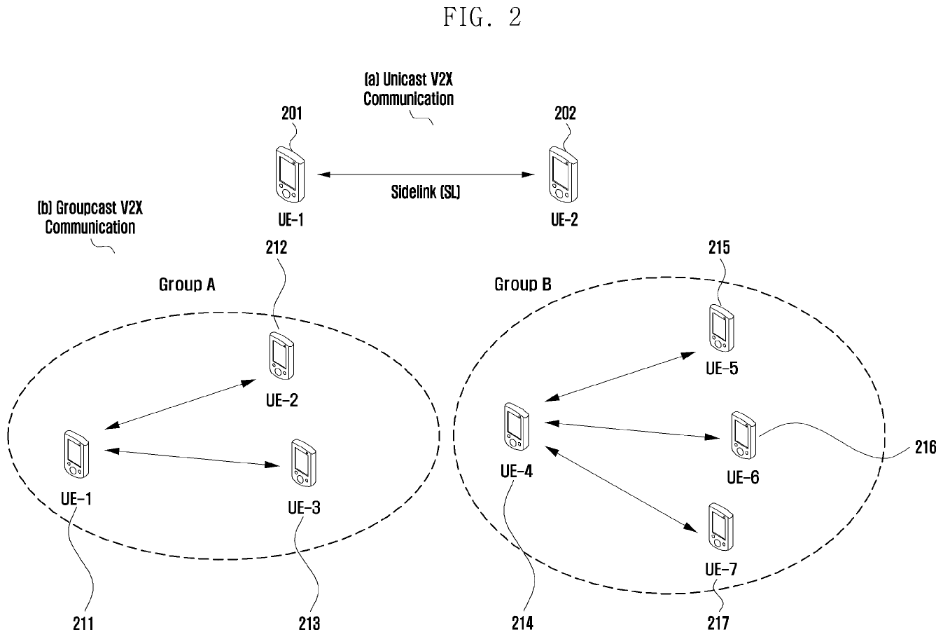

FIG. 2 is a diagram illustrating a V2X communication method performed through a sidelink according to an embodiment of the disclosure.

With reference to FIG. 2A, a UE-1, 201 (e.g., TX UE) and a UE-2, 202 (e.g., RX UE) may perform one-to-one communication, which may be referred to as unicast communication.

With reference to FIG. 2B, a TX UE and an RX UE may perform one-to-many communication, which may be referred to as groupcast or multicast. In FIG. 2B, a UE-1, 211, UE-2, 212, and UE-3, 213 form one group (Group A) to perform groupcast communication, and a UE-4, 214, UE-5, 215, UE-6, 216, and UE-7, 217 form another group (Group B) to perform groupcast communication. Each UE may perform groupcast communication only within a group to which it belongs, and communication between different groups may be performed through unicast, groupcast, or broadcast communication. In FIG. 2B, although it is illustrated that two groups (Group A, Group B) are formed, the disclosure is not limited thereto.

Although not illustrated in FIG. 2, V2X UEs may perform broadcast communication. Broadcast communication means the case that all V2X UEs receive data and control information transmitted by a V2X transmitting UE through a sidelink. As an example, in FIG. 2B, in the case that it is assumed that a UE-1, 211 is a transmitting UE for broadcast, all UEs (UE-2, 212, UE-3, 213, UE-4, 214, UE-5, 215, UE-6, 216, and UE-7, 217) may receive data and control information transmitted by the UE-1, 211.

In NR V2X, the support of a form in which a vehicle UE transmits data to only one specific node through unicast and a form in which a vehicle UE transmits data to specific multiple nodes through a groupcast may be considered, unlike in LTE V2X. For example, such unicast and groupcast technologies may be usefully used in service scenarios such as platooning, which is a technology for moving two or more vehicles in a group by connecting them to one network. Specifically, unicast communication may be required for the purpose of controlling one specific node by a leader node of a group connected by platooning, and groupcast communication may be required for the purpose of simultaneously controlling a group consisting of specific multiple nodes.

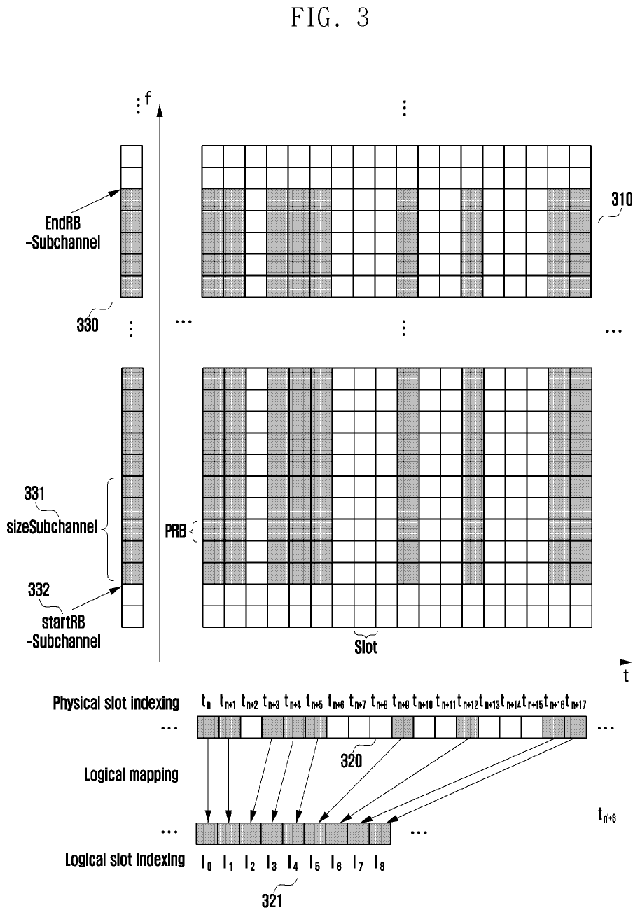

FIG. 3 is a diagram illustrating a resource pool defined as a set of resources on a time and frequency used for transmission and reception of a sidelink according to an embodiment of the disclosure.

In the resource pool, a resource granularity of the time axis may be a slot. Further, a resource granularity of the frequency axis may be a sub-channel composed of one or more physical resource blocks (PRBs).

In the case that a resource pool is allocated on a time and frequency (310), a colored area indicates an area configured as a resource pool on a time and frequency. In the disclosure, an example of the case that the resource pool is discontinuously allocated on a time is described, but the resource pool may be continuously allocated on a time. Further, although the disclosure exemplifies the case that the resource pool is continuously allocated on a frequency, a method in which the resource pool is discontinuously allocated on a frequency is not excluded.

With reference to FIG. 3, a case 320 that a resource pool is discontinuously allocated on a time is illustrated. FIG. 3 illustrates the case that a granularity of resource allocation on a time consists of slots. Specifically, one slot composed of a plurality of OFDM symbols may be a basic unit of resource allocation on the time axis. In this case, all OFDM symbols constituting the slot may be used for sidelink transmission, and some OFDM symbols constituting the slot may be used for sidelink transmission. For example, a part of the slot may be used as a downlink/uplink used as a Uu interface between the base station and the UE. With reference to FIG. 3, a colored slot indicates a slot included in a resource pool on a time, and a slot allocated to the resource pool may be (pre-)configured as resource pool information on a time. In the disclosure, the meaning of (pre-)configuration may mean configuration information pre-configured in the UE to be stored in advance, or may mean the case that the UE is configured in a cell-common manner from the base station. Here, cell-common may mean that UEs in a cell receive a configuration of the same information from the base station. In this case, a method in which the UE receives a sidelink system information block (sidelink SL-SIB) from the base station to obtain cell-common information may be considered. Further, cell-common may mean the case that the UE is configured in a UE-specific manner after the RRC connection with the base station is established. Here, UE-specific may be replaced with the term UE-dedicated, and mean that configuration information is received with a specific value for each UE. In this case, a method in which the UE receives an RRC message from a base station to obtain UE-specific information may be considered.

With reference to FIG. 3, a physical slot 320 belonging to a resource pool that is non-consecutive on a time may be mapped to a logical slot 321. In general, a set of slots belonging to a physical sidelink shared channel (PSSCH) resource pool may be represented by (t0, t1, . . . , ti, . . . , tTmax).

With reference to FIG. 3, a case 330 that a resource pool is continuously allocated on a frequency is illustrated.

In the frequency axis, resource allocation may be made in units of sub-channels 331 within a sidelink bandwidth part (BWP). The sub-channel 331 may be defined as a resource allocation unit on a frequency composed of one or more RBs. That is, the sub-channel 331 may be defined as an integer multiple of RB. With reference to FIG. 3, the sub-channel 331 may be composed of 5 consecutive PRBs, and the size of the sub-channel (sizeSubchannel) may be the size of 5 consecutive PRBs. However, the content illustrated in the drawings is only an example of the disclosure, and the size of a sub-channel may be configured differently, and although it is general that one sub-channel is composed of continuous PRBs, it is not necessary to be composed of continuous PRBs. The sub-channel 331 may be a basic unit of resource allocation for a PSSCH.

A startRB-Subchannel 332 may indicate a start position of the sub-channel 331 on a frequency in the resource pool. In the case that resource allocation is performed in units of sub-channels 331 in the frequency axis, resources on a frequency may be allocated through configuration information such as the RB index (startRB-Subchannel) 332 from which the sub-channel 331 starts, information (sizeSubchannel) on how many RBs the sub-channel 331 consists of, and the total number (numSubchannel) of sub-channels 331, and the like. In this case, information on a startRB-Subchannel, a sizeSubchannel, a numSubchannel, and the like may be (pre-)configured as resource pool information on a frequency.

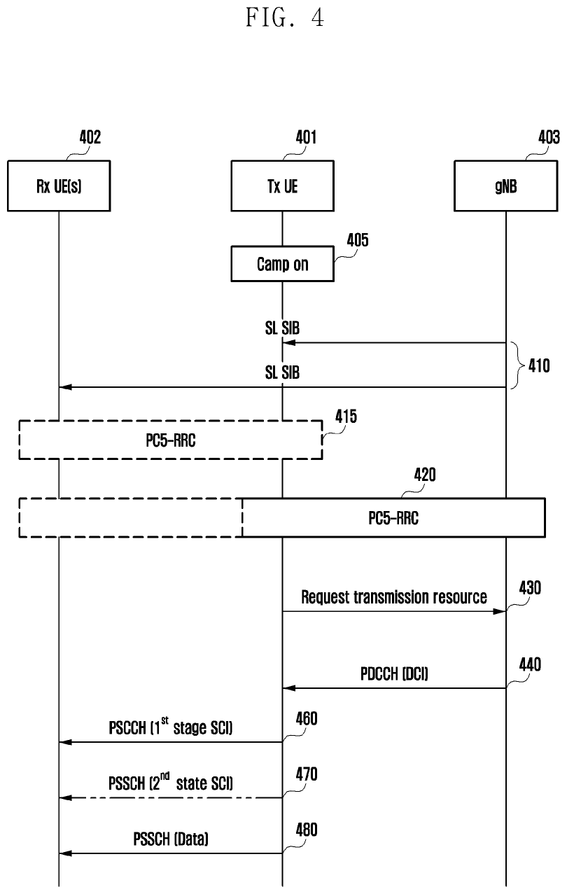

FIG. 4 is a message flow diagram illustrating a method for a base station to allocate transmission resources in a sidelink according to an embodiment of the disclosure.

A method for the base station to allocate transmission resources in the sidelink will be referred to as a mode 1 hereinafter. The mode 1 may be scheduled resource allocation. The mode 1 may indicate a method in which the base station allocates resources used for sidelink transmission to RRC-connected UEs in a dedicated scheduling method. The method of the mode 1 may be effective for interference management and resource pool management because the base station may manage sidelink resources.

With reference to FIG. 4, a transmitting UE 401 and a receiving UE 402 that are camping on 405 may receive a sidelink system information block (SL-SIB) from a base station 403 (410). Here, the receiving UE 402 indicates a UE receiving data transmitted by the transmitting UE 401. The SL-SIB information may include sidelink resource pool information for sidelink transmission and reception, parameter configuration information for sensing operation, information for configuring sidelink synchronization, or carrier information for sidelink transmission and reception operating at different frequencies.

When data traffic for V2X is generated in the transmitting UE 401, the transmitting UE 401 may be RRC-connected to the base station 403 (420). Here, the RRC connection between the UE and the base station may be referred to as Uu-RRC. The Uu-RRC connection process 420 may be performed before data traffic generation of the transmitting UE 401. Further, in the mode 1, in a state in which the Uu-RRC connection process 420 between the base station 403 and the receiving UE 402 is performed, the transmitting UE may perform transmission to the receiving UE through a sidelink. Alternatively, in the mode 1, even in a state in which the Uu-RRC connection process 420 between the base station 403 and the receiving UE 402 is not performed, the transmitting UE may perform transmission to the receiving UE through the sidelink.

The transmitting UE 401 may request a transmission resource capable of performing V2X communication with the receiving UE 402 to the base station (430). In this case, the transmitting UE 401 may request a sidelink transmission resource to the base station 403 using a physical uplink control channel (PUCCH), an RRC message, or a MAC CE. The MAC CE may be a buffer status report (BSR) MAC CE of a new format (including an indicator indicating that it is a buffer status report for at least V2X communication and information on a size of data buffered for D2D communication). Further, the transmitting UE 401 may request a sidelink resource through a scheduling request (SR) bit transmitted through a PUCCH.

Hereinafter, the base station 403 may allocate a V2X transmission resource to the transmission UE 401. In this case, the base station may allocate transmission resources in a dynamic grant or configured grant scheme.

First, in the case of the dynamic grant scheme, the base station may allocate resources for TB transmission through downlink control information (DCI). Sidelink scheduling information included in DCI may include parameters related to a transmission occasion and frequency allocation position information fields of initial transmission and retransmission. DCI for the dynamic grant scheme may be CRC scrambled with SL-V-RNTI so as to indicate that it is a dynamic grant scheme.

Hereinafter, in the case of the configured grant scheme, the base station may periodically allocate resources for TB transmission by configuring a semi-persistent scheduling (SPS) interval through a Uu-RRC. In this case, the base station may allocate resources for one TB through DCI. Sidelink scheduling information for one TB included in DCI may include parameters related to a transmission occasion and frequency allocation position information of initial transmission and retransmission resources. In the case that resources are allocated in the configured grant scheme, a transmission occasion and frequency allocation position of initial transmission and retransmission for one TB may be determined by the DCI, and a resource for a next TB may be repeated at SPS intervals. DCI on the configured grant scheme may be CRC scrambled with SL-SPS-V-RNTI so as to indicate that it is a configured grant scheme. Further, the configured grant (CG) scheme may be divided into a type1 CG and a type2 CG. In the case of the Type2 CG, it is possible to activate/deactivate a resource configured as a configured grant through DCI.

Accordingly, in the case of the mode 1, the base station 403 may transmit DCI through a PDCCH to instruct the transmitting UE 401 to schedule sidelink communication with the receiving UE 402 (440).

Specifically, DCI used by the base station 403 for sidelink communication to the transmitting UE 401 may include a DCI format 3_0 or a DCI format 3_1. The DCI format 3_0 may be defined as DCI for scheduling an NR sidelink in one cell, and the DCI format 3_1 may be defined as DCI for scheduling an LTE sidelink in one cell.

In the case of broadcast transmission, the transmitting UE 401 may perform transmission without an RRC configuration 415 for the sidelink. Alternatively, in the case of unicast or groupcast transmission, the transmitting UE 401 may perform RRC connection with another UE on a one-to-one basis. Here, an inter-UE RRC connection may be referred to as a PC5-RRC 415 to be distinguished from the Uu-RRC. In the case of groupcast, the PC5-RRC 415 may be individually connected between the UE and the UE in the group. With reference to FIG. 4, although the connection of the PC5-RRC 415 is illustrated as an operation after the transmission 410 of the SL-SIB, it may be performed at any time before the transmission 410 of the SL-SIB or before the transmission of the SCI.

Hereinafter, the transmitting UE 401 may transmit a 1st stage (SCI) to the receiving UE 402 through a PSCCH (460). Further, the transmitting UE 401 may transmit a 2nd stage (SCI) to the receiving UE 402 through a PSSCH (470). In this case, information related to resource allocation may be included in the 1st stage SCI, and other control information may be included in the 2nd stage SCI. Further, the transmitting UE 401 may transmit data to the receiving UE 402 through the PSSCH (480). In this case, the 1st stage (SCI), the 2nd stage (SCI), and the PSSCH may be transmitted together in the same slot.

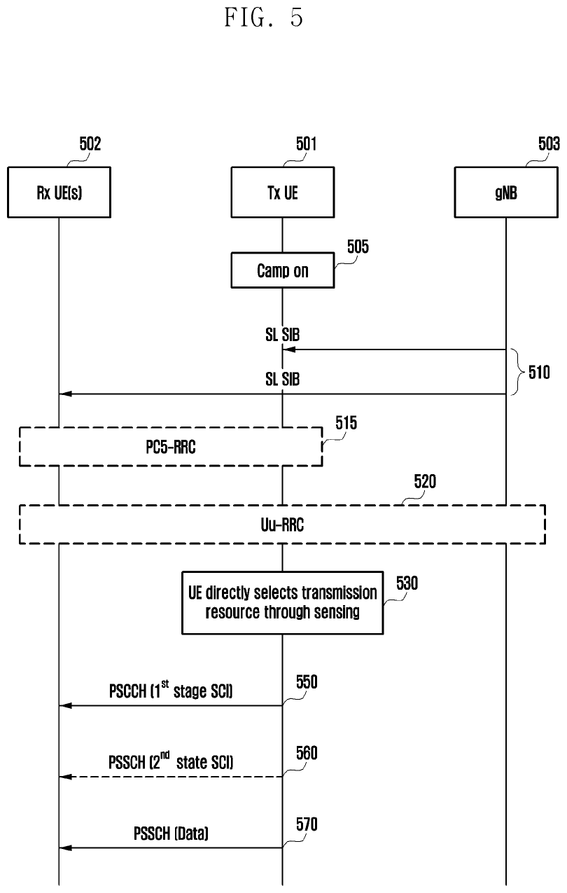

FIG. 5 is a message flow diagram illustrating a method in which a UE directly allocates a transmission resource of a sidelink through sensing in a sidelink according to an embodiment of the disclosure. Hereinafter, a method in which the UE directly allocates a transmission resource of the sidelink through sensing in the sidelink will be referred to as a mode 2. The mode 2 may be referred to as UE autonomous resource selection. In the mode 2, a base station 503 may provide a sidelink transmission and reception resource pool for V2X as system information, and a transmission UE 501 may select a transmission resource according to a predetermined rule. Unlike a mode 1 in which the base station directly participates in resource allocation, in FIG. 5, there is a difference in that the transmitting UE 501 autonomously selects resources and transmits data based on a resource pool previously received through system information.

With reference to FIG. 5, the transmitting UE 501 and the receiving UE 502 that are camping on (505) may receive an SL-SIB from a base station 503 (510). Here, the receiving UE 502 indicates a UE receiving data transmitted by the transmitting UE 501. SL-SIB information may include sidelink resource pool information for sidelink transmission and reception, parameter configuration information for a sensing operation, information for configuring sidelink synchronization, or carrier information for sidelink transmission and reception operating at different frequencies.

The difference between FIGS. 4 and 5 is that in FIG. 4, the base station 503 and the UE 501 operate in an RRC connected state, whereas in FIG. 5, the UE may operate even in an idle mode 520 (RRC unconnected state). Further, even in the RRC connected state 520, the base station 503 may enable the transmitting UE 501 to autonomously select a transmission resource without directly participating in resource allocation. Here, the RRC connection between the UE 501 and the base station 503 may be referred to as a Uu-RRC 520. When data traffic for V2X is generated in the transmitting UE 501, the transmitting UE 501 may receive a configuration of a resource pool through system information received from the base station 503, and the transmitting UE 501 may directly select a resource in the time/frequency domain through sensing within the configured resource pool (530). When a resource is finally selected, the selected resource is determined as a grant for sidelink transmission.

In the case of broadcast transmission, the transmitting UE 501 may perform transmission without an RRC configuration 515 for the sidelink. Alternatively, in the case of unicast or groupcast transmission, the transmitting UE 501 may perform RRC connection with another UE on a one-to-one basis. Here, an inter-UE RRC connection may be referred to as a PC5-RRC 515 to be distinguished from the Uu-RRC. In the case of groupcast, the PC5-RRC 515 may be individually connected between the UE and the UE in the group. With reference to FIG. 5, although the connection of the PC5-RRC 515 is illustrated as an operation after the transmission 510 of the SL-SIB, it may be performed at any time before transmission 510 of the SL-SIB or before transmission of the SCI.

Hereinafter, the transmitting UE 501 may transmit a 1st stage (SCI) to the receiving UE 502 through a PSCCH (550). Further, the transmitting UE 401 may transmit a 2nd stage (SCI) to the receiving UE 402 through a PSSCH (560). In this case, information related to resource allocation may be included in the 1st stage SCI, and other control information may be included in the 2nd stage SCI. Further, the transmitting UE 501 may transmit data to the receiving UE 502 through the PSSCH (570). In this case, the 1st stage (SCI), the 2nd stage (SCI), and the PSSCH may be transmitted together in the same slot.

Specifically, the SCI used by the transmitting UEs 401 and 501 for sidelink communication to the receiving UEs 402 and 502 may use an SCI format 1-A as a 1st stage (SCI). Further, an SCI format 2-A or an SCI format 2-B may be used as the 2nd stage (SCI). In the second stage (SCI), the SCI format 2-A may be used by including information for PSSCH decoding in the case that HARQ feedback is not used or in the case that HARQ feedback is used and in the case that both ACK and NACK information are included. Alternatively, the SCI format 2-B may be used by including information for PSSCH decoding in the case that HARQ feedback is not used or in the case that HARQ feedback is used and in the case that only NACK information is included. For example, the SCI format 2-B may be limitedly used for groupcast transmission.

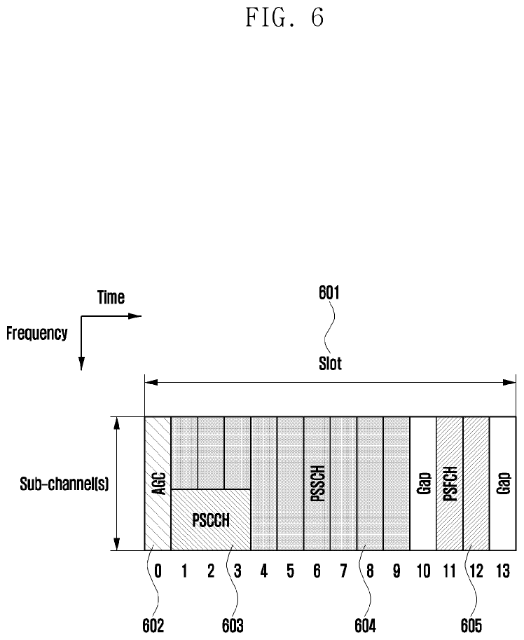

FIG. 6 is a diagram illustrating a mapping structure of physical channels mapped to one slot in a sidelink according to an embodiment of the disclosure.

Specifically, FIG. 6 illustrates mapping for PSCCH/PSSCH/PSFCH physical channels. A PSCCH/PSSCH/PSFCH may be allocated to one or more sub-channels on a frequency. Details of sub-channel allocation refer to the description of FIG. 3. Hereinafter, in order to describe temporal mapping of a PSCCH/PSSCH/PSFCH, with reference to FIG. 6, before the transmitting UE transmits a PSCCH/PSSCH/PSFCH to a corresponding slot 601, one or more symbols may be used as an area 602 for automatic gain control (AGC). In the case that the corresponding symbol(s) is(are) used for AGC, a method of repeatedly transmitting a signal of another channel in the corresponding symbol area may be considered. In this case, a repeated signal of another channel may consider a portion of a PSCCH symbol or a PSSCH symbol. Alternatively, a preamble may be transmitted in an AGC area. In the case that a preamble signal is transmitted, there is an advantage that an AGC execution time may be further shortened compared to a method of repeatedly transmitting signals of other channels. In the case that a preamble signal is transmitted for AGC, a specific sequence may be used as the preamble signal 602, and in this case, a sequence such as a PSSCH DMRS, PSCCH DMRS, and CSI-RS may be used as the preamble. A sequence used as the preamble in the disclosure is not limited to the above-described example. Additionally, with reference to FIG. 6, a PSCCH 603 including control information may be transmitted to initial symbols of the slot, and data scheduled by control information of the PSCCH 603 may be transmitted to a PSSCH 604. A part (1st stage SCI) of sidelink control information (SCI), which is control information, may be mapped and transmitted to the PSCCH 603. Another part (2nd stage SCI) of SCI, which is control information as well as data information may be mapped and transmitted to the PSSCH 604. Further, FIG. 6 illustrates that a physical sidelink feedback channel (PSFCH) 605, which is a physical channel for transmitting feedback information, is positioned in a last part of a slot. By securing a predetermined empty gap between the PSSCH 604 and the PSFCH 605, the UE that has transmitted and received the PSSCH 604 may prepare to transmit or receive the PSFCH 605. Further, after transmission and reception of the PSFCH 605, a predetermined empty gap may be secured.

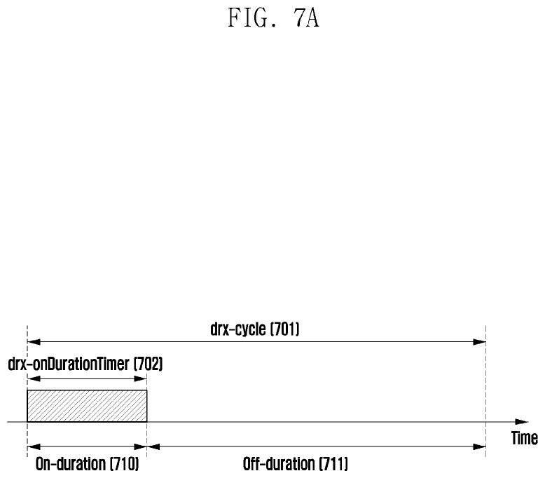

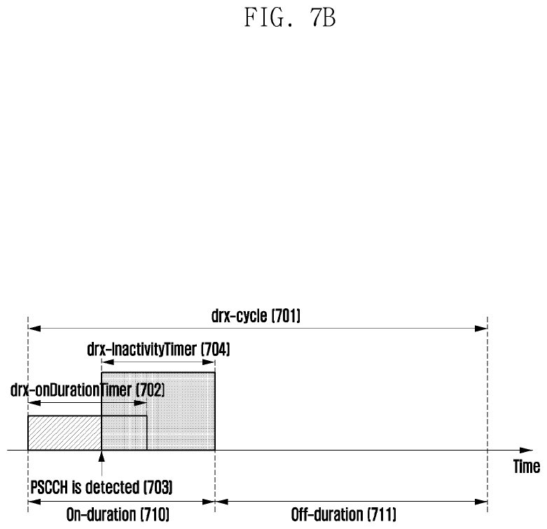

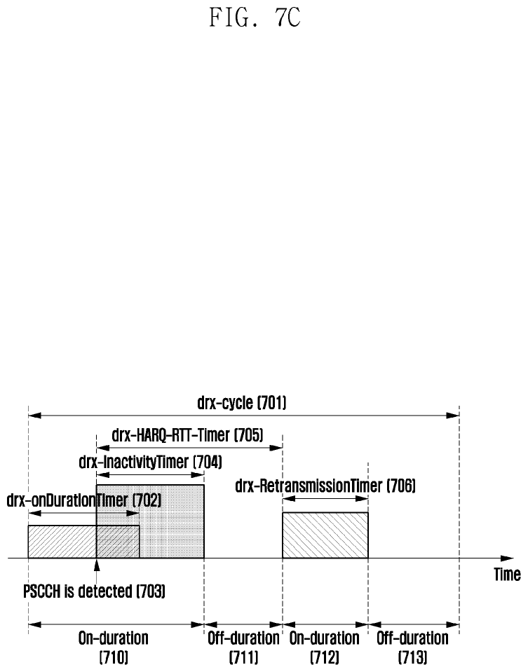

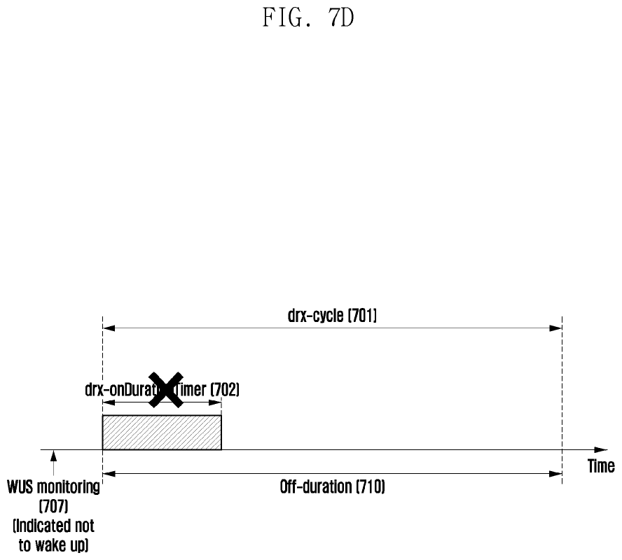

FIGS. 7A to 7D are diagrams illustrating DRX off-duration and on-duration determined according to parameters configured for DRX when discontinuous reception (DRX) is performed in a sidelink according to an embodiment of the disclosure. Here, DRX on-duration may be referred to as an active time for DRX. The UE may perform decoding on control information and data information in a period corresponding to DRX on-duration. Further, in a period corresponding to DRX off-duration, decoding on control information and data information may not be performed. In the sidelink, there are 1st SCI, which is control information transmitted through a PSCCH, and 2nd SCI, which is control information transmitted through a PSSCH. Further, data information may be transmitted through the PSSCH. It may be assumed that control information and data information are always transmitted simultaneously in the sidelink. Accordingly, a time point at which control information is received may be the same as a time point at which data information is received.

The following may be considered as parameters for determining DRX off-duration and on-duration of the sidelink. However, it is noted that in the disclosure, parameters for determining DRX off-duration and on-duration are not limited to parameters presented below. Further, it is noted that some of the following parameters may not be used in sidelink DRX.

### DRX Related Parameters

d-cycle
   Details of a DRX cycle configuration method and a start position (drx-StartOffset) to which DRX is applied as a cycle to which DRX is applied refer to FIGS. 7A to 7D. In the sidelink, a drx-cycle may have a long cycle and a short cycle, and a method of configuring this refers to the following embodiment.
drx-onDurationTimer
   Control information and data information of the sidelink may be decoded until a drx-onDurationTimer as a time operating with DRX on-duration operates and expires in a drx-cycle. Details of an onDurationTimer refer to FIGS. 7A to 7D.
drx-InactivityTimer
   When sidelink control information is received before the drx-onDurationTimer expires, DRX on-duration may be extended from a time point at which control information is received until a drx-InactivityTimer operates and expires. Details of the drx-InactivityTimer refer to FIGS. 7A to 7D.
drx-HARQ-RTT-Timer
   In the case that retransmission is performed in the sidelink, and in the case that the UE receives sidelink control information in DRX on-duration, the drx-HARQ-RTT-Timer may be applied until next retransmission is received. As described above, because position information of initial transmission and retransmission resources is indicated in 1st SCI, the drx-HARQ-RTT-Timer may be assumed as a time gap between initial transmission and retransmission resources or a time gap between retransmission resources. Details of the drx-HARQ-RTT-Timer refer to FIGS. 7A to 7D.
drx-RetransmissionTimer
   In the case that retransmission is performed in the sidelink, the drx-RetransmissionTimer may operate from a time point at which the drx-HARQ-RTT-Timer expires. It may be assumed that the drx-RetransmissionTimer does not operate during a time period in which the drx-HARQ-RTT-Timer operates. Further, in the sidelink, the drx-RetransmissionTimer may be assumed and configured to a fixed value of one slot or one subframe. Details of the drx-RetransmissionTimer refer to FIGS. 7A to 7D.
drx-SlotOffset
   In the case that various subcarrier spacings (SCS) are supported, the drx-SlotOffset may be used for the purpose of adjusting a starting position to which DRX is applied.
Wake-up signal (WUS) cycle
   In the case that a WUS is used, details of a cycle at which the WUS is transmitted refer to FIGS. 7A to 7D.

With reference to FIG. 7A, an example in which DRX off-duration and on-duration are determined through a drx-cycle and a drx-onDurationTimer is illustrated. When a drx-cycle 701 is started, a time period from the start of a drx-onDurationTimer 702 to expiration is DRX on-duration 710, and the UE may receive sidelink control information. The remaining drx-cycle period from a time point at which the drx-onDurationTimer 702 has expired is configured as DRX off-duration 711; thus, the UE may not receive control and data information.

With reference to FIG. 7B, an example in which DRX off-duration and on-duration are determined through a drx-cycle, a drx-onDurationTimer, and a drx-InactivityTimer is illustrated. When the drx-cycle 701 is started, a time period from the start of the drx-onDurationTimer 702 to expiration thereof is DRX on-duration 710, and the UE may receive sidelink control information. In the case that sidelink control information is received through a PSCCH in the DRX on-duration 710 (703), the DRX on-duration 710 may be extended during a time period in which a drx-InactivityTimer 704 starts from the corresponding time point until the drx-InactivityTimer expires. In the case that sidelink control information is not received until a time point at which the DRX on-duration 710 ends, the remaining drx-cycle period is configured to DRX off-duration 711; thus, the UE may not receive control and data information.

With reference to FIG. 7C, an example in which DRX off-duration and on-duration are determined by using a drx-HARQ-RTT-Timer and a drx-HARQ-RTT-Timer is illustrated. First, when the drx-cycle 701 starts, a time period from the start of the drx-onDurationTimer 702 until the drx-onDurationTimer 702 expires is DRX on-duration 710, and the UE may receive sidelink control information. In the case that sidelink control information is received through a PSCCH in the DRX on-duration 710 (703), the DRX on-duration 710 may be extended during a time period from the corresponding time point until the drx-InactivityTimer 704 starts and expires. In the case that sidelink control information is not received until an end point of the DRX on-duration 710, the remaining drx-cycle period is configured to the DRX off-duration 711; thus, the UE may not receive control and data information. Further, in the case that sidelink control information is received through a PSCCH in the DRX on-duration 710 (703), the control information (see control information included in the above-described 1st SCI) may include information related to retransmission. Specifically, the control information may include whether a retransmission resource is reserved and position information of a resource in which the retransmission resource is to be transmitted. Accordingly, a time gap between initial transmission and retransmission resources included in the control information or a time gap between retransmission resources may be configured to a drx-HARQ-RTT-Timer 705. From a time point at which the drx-HARQ-RTT-Timer 705 expires, a drx-RetransmissionTimer 706 may operate. Further, in the sidelink, the drx-RetransmissionTimer may be assumed and configured to a fixed value of one slot or one subframe. The disclosure is not limited thereto. That is, in the sidelink, the drx-RetransmissionTimer may be configured to a value of one or more slots or one or more subframes. Therefore, as illustrated in FIG. 7C, a period in which the drx-RetransmissionTimer 706 operates may be configured to DRX on-duration 712; thus, the UE may receive retransmission. Further, the remaining drx-cycle period may be configured to DRX off-duration 713; thus, the UE may not receive control and data information.

With reference to FIG. 7D, an example in which DRX off-duration and on-duration are determined by using a wake-up signal (WUS) is illustrated. In the case that the WUS is used in the sidelink, a cycle in which the WUS is transmitted may be configured. The UE may monitor the WUS at a position in which the WUS is transmitted (707). As illustrated in FIG. 7D, in the case that the WUS is indicated that the UE does not wake up in 707, the UE does not operate the drx-onDurationTimer 702 in the drx-cycle 701 and all drx-cycle periods are configured to DRX off-duration 710; thus, the UE may not receive control and data information. Alternatively, in the case that the WUS is indicated that the UE wakes up in 707, the UE may perform operations illustrated in FIGS. 7A, 7B, and 7C according to the configured DRX parameters.

Therefore, with reference to FIGS. 7A to 7D, DRX on-duration (or active time) may be defined as the following condition.
When a DRX cycle is configured, on-duration (or active time) may include the following.
   When a drx-onDurationTimer, a drx-InactivityTimer, or a drx-RetransmissionTimer operates

The disclosure introduces methods of matching wake-up time points between UEs performing communication in the sidelink so that the UE may receive control information and data information in DRX duration. When a DRX-related configuration is understood equally between UEs performing communication in the sidelink, transmission and reception between UEs may be performed without any problem. The configurable DRX parameters refer to the above presented DRX related parameters. Among the configurable DRX parameters, at least a drx-cycle and DRX on-duration (or active time) by the drx-onDurationTimer need to be matched between sidelink UEs. As described with reference to FIGS. 7A to 7D, a wake-up time point in the DRX duration of the UE and a period for receiving control information and data information may be determined by the drx-cycle and the drx-onDurationTimer. As described with reference to FIGS. 7A to 7D, conditions in which the drx-InactivityTimer or the drx-RetransmissionTimer operate are determined according to whether control channel reception and decoding is successful; thus, DRX on-duration (or active time) may vary for each UE. Specifically, DRX on-duration (or active time) may be divided as follows.
DRX on-duration 1: Duration in which the UE may wake up in DRX duration by a drx-cycle and a drx-onDurationTimer to receive control information and data information, and in the case that the corresponding DRX parameters are matched and configured between UEs in the sidelink, duration (DRX on-duration) awakened by the corresponding value may be the same at all UEs of the sidelink.
DRX on-duration 2: Duration in which the UE may wake up in DRX duration by a drx-cycle, a drx-onDurationTimer, and a drx-InactivityTimer or a drx-RetransmissionTimer to receive control information and data information, and as described with reference to FIGS. 7A to 7D, because conditions in which a drx-InactivityTimer or a drx-RetransmissionTimer operate are determined according to whether control channel reception and decoding is successful, duration (DRX on-duration) waken up by the corresponding DRX parameter may be different in all UEs of the sidelink.

Specifically, the following methods may be used as a method of configuring the DRX parameter in the sidelink. The disclosure is not limited to the following methods. Further, it is noted that the following methods my be used in combination.

### Method of Configuring DRX Parameters

Method 1: DRX parameters are pre-configured or cell-commonly configured with resource pool information.
Method 2: DRX parameters are UE-specifically configured with resource pool information.
Method 3: DRX parameter is indicated by L1 signaling.
Method 4: DRX parameter is configured to PC5-RRC.

The method 1 is a method in which the DRX parameter is configured in the same method as a method in which the UE performs sidelink transmission and reception in the resource pool by pre-configuring resource pool information in the UE or by cell-commonly configuring resource pool information by the base station through an SL SIB. In the case of the method 1, all UEs belonging to the corresponding pool may transmit and receive with the same DRX parameter configuration information.

The case that only a method 2 is considered may not be used because different DRX parameters may be configured between UEs. However, it may be considered that the method 2 is used in conjunction with the method 3 or the method 4.

The method 3 is a method in which DRX parameter information is configured through L1 signaling. As the L1 signaling method, a method indicated through 1st SCI, indicated through 2nd SCI, or indicated through a WUS signal may be considered. Further, a set of DRX parameters that may be indicated by L1 signaling may be configured by the method 1 or the method 2. Specifically, the following methods of indicating DRX parameter information through L1 signaling may be considered. It is noted that the disclosure is not limited to only the following methods and that a combination of the following methods may be used.

### Method of Indicating DRX Parameter Information Through L1 Signaling

Method 3-1: Indicate a short-drx-cycle by L1 signaling
Method 3-2: Indicate UE-specifically DRX parameters by L1 signaling

In the case of the method 3-1, a long-period drx-cycle (Long-drx-cycle) assumes a longest drx-cycle among configurable drx-cycles as a default drx-cycle, or a method configured through the method 1 may be considered. The method 3-1 is a method in which the UE indicates a drx-cycle (Short-drx-cycle) of a short cycle by L1 signaling, as needed. Through this method, the UE may perform DRX operation in a short period.

In the case of the method 3-2, first, a method in which a specific value among configurable DRX parameters is assumed to a default value or in which a DRX parameter is configured through the method 1 may be considered. The method 3-2 is a method of UE-specifically configuring DRX parameters through L1 signaling. The method 3-2 does not limit a DRX parameter that may be indicated through L1 signaling to a specific parameter. In the case that the method 3 is used and that the UE receives L1 signaling from multiple UEs in the sidelink and receives an indication of different drx-cycles, that the UE may assume a short drx-cycle. Further, in the case that the method 3 is used and that the UE receives L1 signaling from multiple UEs in the sidelink and receives an indication of different DRX parameters, the UE may assume DRX parameters based on a priority. Specifically, it may be assumed as a DRX parameter transmitted by a UE corresponding to a high priority. In this case, the priority may be priority information included in the 1st SCI. Alternatively, the priority may be newly defined and signaled information, unlike an existing priority value included in the 1st SCI.

Further, the method 4 is a method in which DRX parameter information is configured through PC5-RRC. In the case of method 4, two operating methods may be considered. A first method is the case that a configuration of DRX parameter information is supported only through PC5-RRC without support of the method 1/2/3. In this case, in the case that a PC5-RRC link between UEs is formed like unicast, sidelink DRX information may be exchanged between UEs through PC5-RRC. A second method is the case that DRX parameter information configuration is supported through PC5-RRC in a state in which one or more of the methods 1/2/3 are considered. In the case that not only communication between UEs that have established a PC5-RRC link but also sidelink communication with a UE that has not established a PC5-RRC link is considered, a DRX parameter configuration through the PC5-RRC needs to consider DRX on-duration by an already configured DRX parameter. Specifically, it is necessary to align DRX on-duration configured to receive the broadcast message and DRX on-duration through the PC5-RRC. When DRX on-duration configured to receive the broadcast message becomes off-duration by a DRX configuration through the PC5-RRC, the UE may not receive the broadcast message.

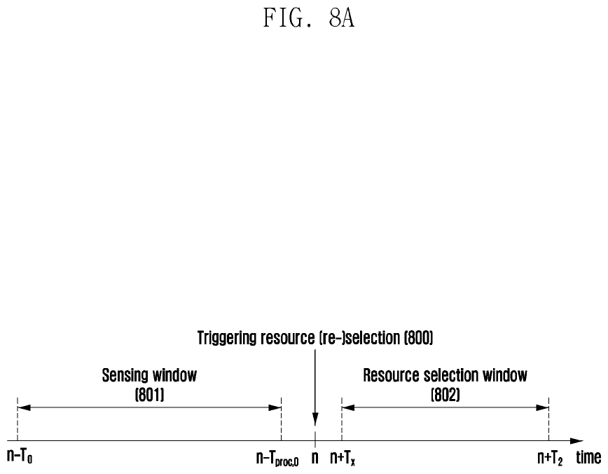

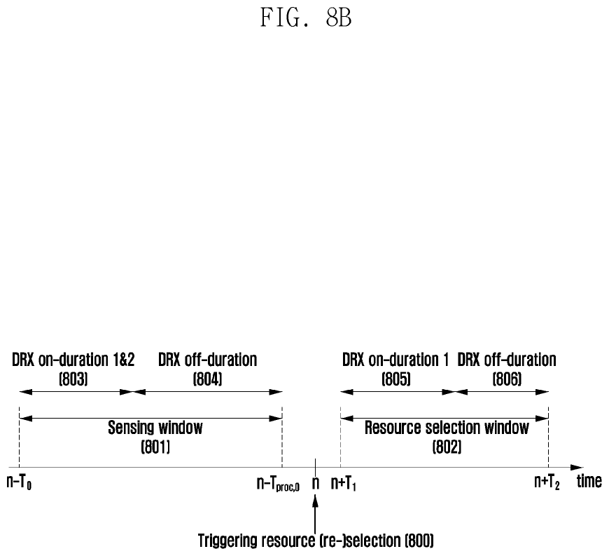

FIGS. 8A and 8B are diagrams illustrating a sensing and resource selection (Mode2) procedure according to an embodiment of the disclosure.

FIG. 8A is a diagram illustrating a Mode2 procedure in which a resource selection procedure is triggered and in which a transmission resource is determined through a sensing window and a resource selection window according to an embodiment of the disclosure.

In FIG. 8A, when triggering for resource (re)selection is performed at a time point (slot) n (800), a sensing window 801 may be defined as [n−T0, n−Tproc,0]. Here, T0 is a starting time point of the sensing window and may be (pre-)configured as resource pool information. T0 is a positive integer of an ms unit, and the disclosure does not limit T0 to a specific value. Further, Tproc,0 may be defined as the time required to process the sensed result. Tproc,0 is a positive integer of an ms unit, and the disclosure does not limit a configured value to a specific value. Further, the sensing window may mean a period configured by converting to a logical slot belonging to a resource pool before a slot n. Sensing by the UE may be interpreted as an operation for performing SCI reception and decoding from another UE in the sensing window 801 and determining whether another UE occupies a specific resource and an amount of interference through sidelink measurement.

In FIG. 8A, when triggering for resource (re)selection is performed at a time point n (800), a resource selection window 802 may be determined as [n+T1, n+T2]. Here, T1 is a value of a slot unit, and may be selected by the UE implementation for T1≤Tproc,1. Tproc,1 may be defined as the maximum reference value in consideration of a processing time required to select a resource. The disclosure does not limit a value configured to Tproc,1 to a specific value. For example, the corresponding value Tproc,1 may be fixed to a specific value (ms) according to subcarrier spacing (SCS). Further, T2 is a value of a slot unit and may be selected by the UE within a range satisfying T2 min≤T2≤Remaining packet delay budget (PDB). Here, T2 min is a value used for preventing the UE from selecting T2 of an excessively small value. Here, a value T2 min ‘T2 min (priority)’ according to a priority may be configured through a higher layer. The UE may perform a process of identifying a candidate resource in the resource selection window 802 using the sensing result measured in the sensing window 801 and a process of selecting a transmission resource in the identified candidate process. Up to the X (≥1) number of transmission resources among candidate resources identified in an upper layer of the UE may be randomly selected. In the case that the X (≥2) number of resources are selected, a resource is selected randomly, and a resource positioned at the front on a time may be determined as an initial transmission resource and a resource positioned at a later time on a time may be determined as a retransmission resource. A resource reservation period is configured and resources may be thus periodically reserved at the same frequency position after a reservation cycle M (ms or number of slots) on a time from the X number of selected resources. Further, already selected resources may be reselected through a re-evaluation process. In the case that pre-emption is activated, in order to ensure successful transmission of high-priority traffic or a UE transmitting the same, even for resources that have already been reserved, an operation of reselecting a resource according to a priority of the UE and the reference signal received power (RSRP) measurement result may be supported.

Hereinafter, the disclosure proposes a method of performing sensing and resource selection in a situation in which the UE operates in DRX. According to a method of configuration a DRX parameter in the sidelink presented above, it may be assumed that wake-up time points between the UEs coincide so that the UE may receive control information and data information in DRX. Further, in this disclosure, it is assumed that DRX may be applied to sidelink broadcast, unicast, and groupcast schemes.

A problem that may occur when a UE in which DRX is performed performs sensing and resource selection will be described with reference to FIG. 8B.

FIG. 8B illustrates a Mode2 procedure in which a resource selection procedure is triggered and in which a transmission resource is determined through a sensing window and a resource selection window according to an embodiment of the disclosure. Further, an example in which DRX is performed and DRX off-duration and on-duration are thus configured; thus, sensing and resource selection occurs in DRX off-duration is illustrated.

Specifically, FIG. 8B illustrates the case that a part of a sensing window 801 is configured to DRX on-duration 803 and that a part of the sensing window 801 is configured to DRX off-duration 804. Further, FIG. 8B illustrates the case that a part of a resource selection window 802 is configured to DRX on-duration 805 and that a part of the resource selection window 802 is configured to DRX off-duration 806.

First, in the case that a part of the sensing window 801 is configured to DRX off-duration 804, a problem occurs that the UE does not perform sensing in the corresponding period. An operation in which the UE performs sensing is an operation in which the UE receives and decodes SCI from another UE in the sensing window 801 and determines whether another UE occupies a specific resource and an amount of interference through sidelink measurement, and this is because the UE cannot receive and decode SCI in DRX off-duration 806. Therefore, in the case that DRX is performed in a sidelink, the UE may perform sensing in the above-described DRX on-duration 1 or DRX on-duration 2. Further, in the case that a part of the resource selection window 802 is configured to the DRX off-duration 806, and in the case that the UE selects and transmits a resource in the corresponding period, there is a possibility that other UEs performing sidelink communication may be also configured to DRX off-duration to not receive the corresponding resource. Therefore, in the case that DRX is performed in a sidelink, the UE may consider resource selection in the above-described DRX on-duration 1. As described above, it may not be known whether DRX on-duration 2 is to be configured to DRX on-duration (or active time) for each UE at a triggering time point n for resource (re)selection in FIG. 8A (800). In this way, an operation of considering resource selection in DRX on-duration 1 during a DRX operation may be a particularly effective operation in unicast. This is because resource reception of other UEs may be ensured in the corresponding period when a resource is selected in consideration of DRX on-duration (or active time) between UEs performing sidelink communication by unicast. However, this needs to be considered even in groupcast and broadcast.

With reference to FIG. 8B, DRX is performed and DRX off-duration and on-duration are thus configured; thus, examples and problems in which sensing and resource selection occur in DRX off-duration were described. As a method for solving this problem, the following methods may be considered. The disclosure is not limited only to the following method.

Sensing and Resource Selection Method when Performing DRX
Method 1: Method of determining a triggering time point n for resource (re)selection to ensure DRX on-duration (or active time) in the sensing window and resource selection period
Method 2: Method of performing sensing and resource selection in a period configured to DRX on-duration (or active time)
Method 3: Method of defining the sensing window and resource selection period to DRX on-duration (or active time)

In the following embodiment, details of the proposed methods are presented through embodiments. It is noted that in the disclosure, the following embodiments may be used in combination with each other. Further, the method proposed below may be applied equally to the case of performing full sensing and partial sensing when the UE performs sensing, or different methods may be applied to each.

### First Embodiment

In the first embodiment, details of the case of using the method 1 as a sensing and resource selection method when performing DRX are provided. The method 1 is a method of determining a triggering time point n for resource (re)selection so as to ensure DRX on-duration (or active time) in a sensing window and a resource selection period.

First, a method of determining a triggering time point (slot) n for resource (re)selection so as to ensure DRX on-duration in the sensing window is proposed. First, X may be defined as a ratio of DRX on-duration in the sensing window. In this case, the triggering time point (slot) n for resource (re)selection may be determined by the following method.
Method 1-1: A triggering time point (slot) n for resource (re)selection is determined so that the sensing window has DRX on-durations 1 and 2 by X % or more

According to the method 1-1, the UE may perform sensing to trigger resource (re)selection to the case that DRX on-durations 1 and 2 are ensured by the threshold (X) % or more in the sensing window [n−T0, n−Tproc,0]. In the disclosure, a value X is not limited to a specific value. For example, X may be 100%. A method in which the value X is determined by the UE implementation may be considered. Alternatively, the value X may be predetermined, may be selected from predetermined candidate values, or may be selected by the UE implementation within a predetermined range. Alternatively, the value X may be configured by the base station. It may be expected that a DRX parameter is configured to satisfy the above condition. For example, assuming that the sensing window is 100 ms, it may be expected that a drx-onDurationTimer in a drx-cycle is configured to 100 ms or more. In the case that such an assumption is not established, the sensing window may be discontinuously generated or reduced.

Hereinafter, a method of determining a triggering time point (slot) n for resource (re)selection so as to ensure DRX on-duration in the resource selection period is proposed. First, Y may be defined as a ratio of DRX on-duration in the resource selection period. In this case, the triggering time point (slot) n for resource (re)selection may be determined by the following method.
Method 1-2: The triggering time point (slot) n for resource (re)selection is determined so that the resource selection period has DRX on-duration 1 by Y % or more

According to the method 1-2, the UE may trigger resource (re)selection at the time point (slot) in which DRX on-duration 1 is ensured to be greater than or equal to the threshold (Y) % in the resource selection period [n+T1, n+T2]. In the disclosure, a value Y is not limited to a specific value. For example, Y may be 100%. A method of determining the value Y by UE implementation may be considered. Alternatively, the value Y may be predetermined, may be selected from predetermined candidate values, or may be selected by the UE implementation within a predetermined range. Alternatively, the value Y may be configured by the base station. It may be expected that a DRX parameter is configured to satisfy the above condition. For example, assuming that the resource selection period is 50 ms, it may be expected that a drx-onDurationTimer in a drx-cycle is configured to 50 ms or more. In the case that such an assumption is not established, the resource selection period may be discontinuously generated or reduced.

In the case of the method proposed in the first embodiment, a triggering time point (slot) n for resource (re)selection is adjusted; thus, a delay in resource transmission may occur. Further, the method is not considered and the triggering time period (slot) for resource (re)selection may be determined by the UE implementation. Accordingly, in order to solve the problem presented in FIG. 8B, methods proposed in the following embodiment may be considered.

### Second Embodiment

In the second embodiment, details of the case of using the method 2 as a sensing method when performing DRX are provided. The method 2 is a method of performing sensing in a period configured to DRX on-duration (or active time). First, a method for the UE to perform sensing may be divided into the following full sensing and partial sensing.
Full sensing: The UE may monitor slots belonging to a resource pool, except for a slot for performing transmission in the sensing window.
Partial sensing: The UE may monitor some slots belonging to a resource pool, except for a slot for performing transmission in the sensing window.

The above monitoring may be interpreted as a process of performing SCI reception and decoding from another UE and performing sidelink measurement. Further, ‘some slots’ for monitoring in partial sensing may be determined by a partial sensing method. In the disclosure, a specific method is not limited to a method of determining ‘some slots’ for monitoring in partial sensing.

According to an embodiment of the disclosure, the following method 2-1 may be considered as a sensing method when performing DRX.

### Method 2-1

Method 2-1-1: In the case that a DRX cycle is configured for a sidelink, the UE may perform monitoring on slots belonging to a resource pool and slots belonging to DRX on-durations 1 and 2, except for a slot performing transmission in the sensing window.
Method 2-1-2: In the case that a DRX cycle is configured for a sidelink, the UE may perform monitoring on some slots belonging to a resource pool and slots belonging to DRX on-durations 1 and 2, except for a slot performing transmission in the sensing window.

In the above method, ‘the case that a DRX cycle is configured for a sidelink’ may be interpreted as ‘the case that DRX is performed in a sidelink’. The method 2-1-1 may be applied when performing full sensing, and the method 2-1-2 may be applied when performing partial sensing. Further, in the method 2-1-2, ‘some slots’ may be determined according to an application method of partial sensing.

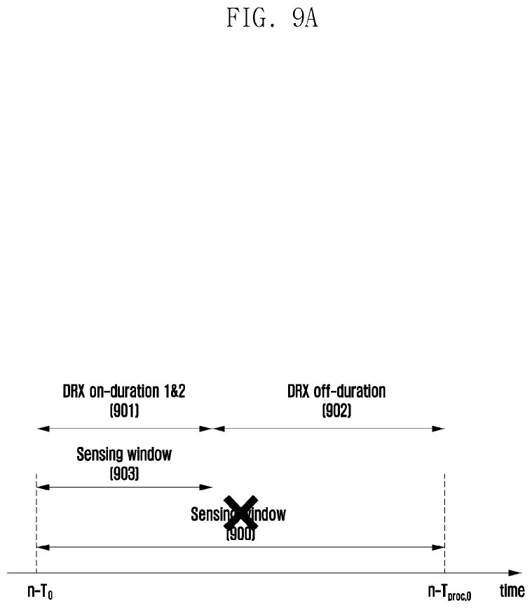

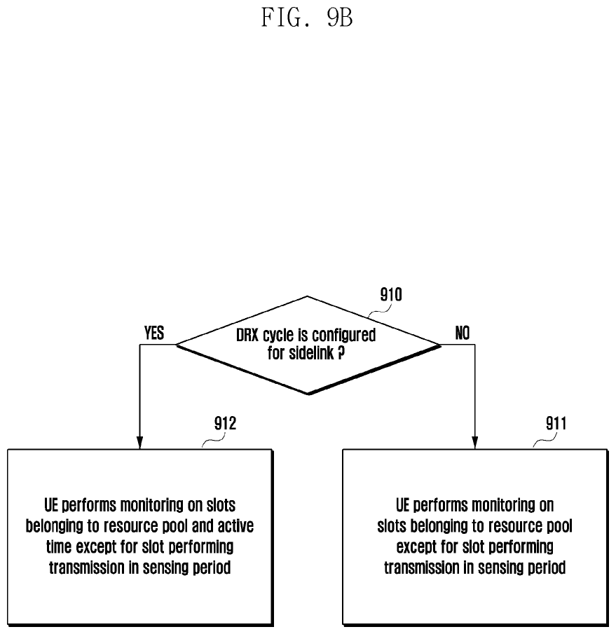

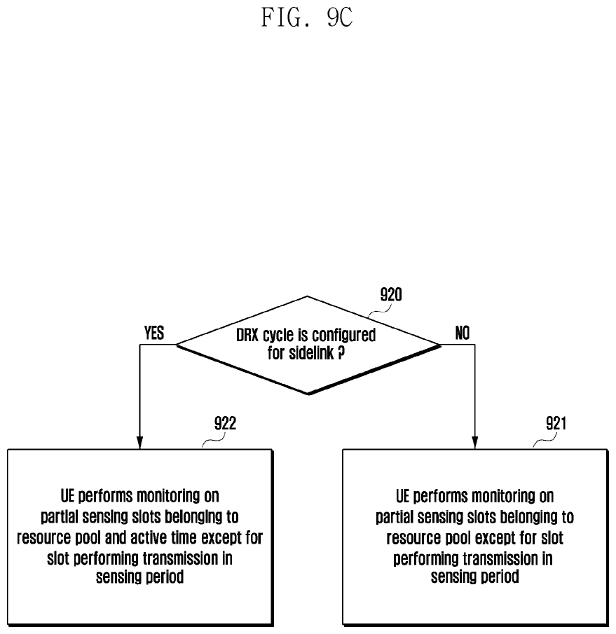

FIG. 9A is a diagram illustrating the method 2-1 according to an embodiment of the disclosure.

FIG. 9A illustrates the case that a sensing window is adjusted to a period configured to DRX on-duration (or active time) according to an embodiment of the disclosure.

FIG. 9A illustrates the case that a sensing window 900 is configured to [n−T0, n−Tproc,0] and that a part of the sensing window is configured to DRX on-duration 901 and that a part of another sensing window is configured to DRX off-duration 902.

FIG. 9A illustrates an example of DRX on-duration and off-duration, and the DRX on-duration and off-duration may be generated in various ways according to DRX parameters. In the above method, DRX on-duration 901 may be assumed as a period including both DRX on-durations 1 and 2. A detailed description of the DRX on-durations 1 and 2 refers to the above description. According to the method proposed in the disclosure, the sensing window may be redefined as in 903 in the DRX on-duration period 901 in FIG. 9A. In the case that DRX on-duration is discontinuous within the sensing window, the sensing window may also be discontinuously generated.

FIG. 9B is a flowchart illustrating a sensing procedure of the case that full sensing is performed according to a method 2-1 of the disclosure.

With reference to FIG. 9B, in step 910, the UE may determine whether a DRX cycle is configured for a sidelink.

In the case that a DRX cycle is not configured, the UE may perform a general full sensing operation within the sensing window in step 911. In the case that a DRX cycle is configured, the UE may perform sensing in a period configured to DRX on-duration (or active time) according to the proposed method in step 912.

FIG. 9C is a flowchart illustrating a sensing procedure of the case that partial sensing is performed according to a method 2-1 of the disclosure.

With reference to FIG. 9C, in step 920, the UE may determine whether a DRX cycle is configured for a sidelink. In the case that a DRX cycle is not configured, the UE performs a general partial sensing operation within a sensing window in step 921. In the case that a DRX cycle is configured, the UE may perform sensing in a period configured to DRX on-duration (or active time) according to the proposed method in step 922. In this case, the number of senseable slots may be very limited.

According to an embodiment of the disclosure, the following method 2-2 may be considered as a sensing method when performing DRX.

### Method 2-2

In the case that a DRX cycle is configured for a sidelink, the UE does not perform sensing.

In the above method, ‘the case that a DRX cycle is configured for a sidelink’ may be interpreted as ‘the case that DRX is performed in a sidelink’. The method 2-2 may be applied to both when performing full sensing and when performing partial sensing. In the case that the method 2-2 is used, because the UE does not perform sensing, random selection may be applied when selecting a resource.

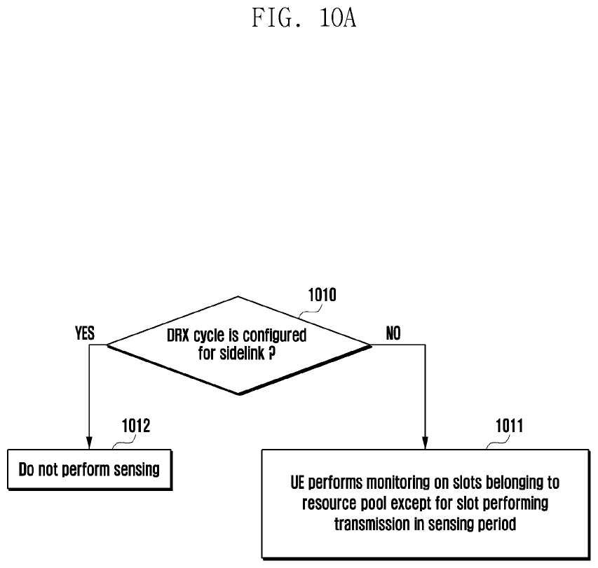

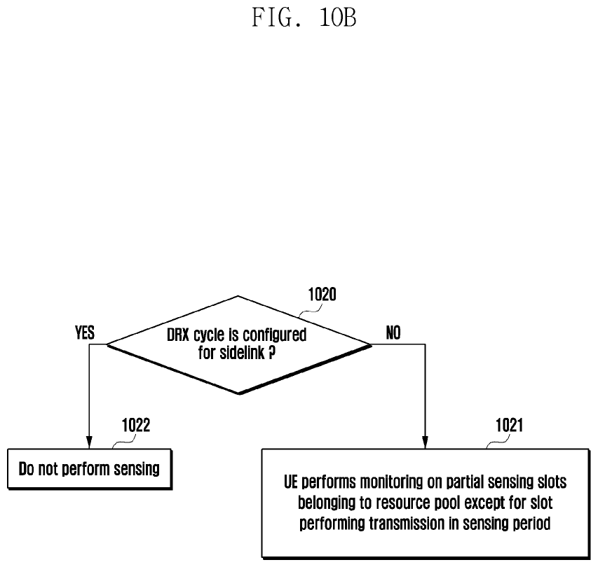

FIG. 10A is a flowchart illustrating a sensing procedure of the case that full sensing is performed according to a method 2-2 of the disclosure.

With reference to FIG. 10A, the UE may determine whether a DRX cycle is configured for a sidelink in step 1010. In the case that a DRX cycle is not configured, the UE may perform a general full sensing operation in a sensing window in step 1011. In the case that a DRX cycle is configured, the UE may not perform sensing according to the proposed method in step 1012.

FIG. 10B is a flowchart illustrating a sensing procedure of the case that partial sensing is performed according to a method 2-2 of the disclosure.

With reference to FIG. 10B, the UE may determine whether a DRX cycle is configured for a sidelink in step 1020. In the case that a DRX cycle is not configured, the UE may perform a general partial sensing operation within the sensing window in step 1021. In the case that a DRX cycle is configured, the UE may not perform sensing according to the proposed method in step 1022.

According to an embodiment of the disclosure, the following method 2-3 may be considered as a sensing method when performing DRX.

### Method 2-3

In the case that a DRX cycle is configured for a sidelink, the UE may determine whether to use the method 2-1 or the method 2-2 based on a ratio of senseable slots in the sensing window.

In the above method, ‘the case that a DRX cycle is configured for a sidelink’ may be interpreted as ‘the case that DRX is performed in a sidelink’. The above method may be applied to both when performing full sensing and when performing partial sensing. A ratio of senseable slots in the sensing window disclosed in the method 2-3 may be defined, for example, by the following equation.

Number of senseable slots when DRX is applied in the sensing window/Number of senseable slots when DRX is not applied in the sensing window Equation 1

In Equation 1, when DRX is applied, the number of senseable slots may be counted in a period including both DRX on-durations 1 and 2. However, Equation 1 is only an example for determining a ratio of senseable slots, and may be expressed in other methods. Therefore, according to a method 2-3, the UE may determine whether to use a method 2-1 or a method 2-2 based on a ratio of senseable slots (e.g., a ratio calculated by Equation 1).

Specifically, in the case that the corresponding ratio is greater than (or greater than or equal to) a threshold Z, the UE may apply a method 2-1. In the case that this is not satisfied, the UE may apply a method 2-2. In the case that the corresponding ratio is greater than (or greater than or equal to) Z, the reason why the UE applies the method 2-1 is that it is determined that the sensing result may be used because a senseable slot is ensured to some extent. In the disclosure, a value of Z is not limited to a specific value. For example, Z may be 100%. A method of determining the value Z by the UE implementation may be considered. Alternatively, the value Z may be predetermined, may be selected from predetermined candidate values, or may be selected by the UE implementation within a predetermined range. Alternatively, the value Z may be configured by the base station.

Further, although the method 2-3 is described a method using a ratio of the senseable slots as a criterion for selecting the method 2-1 and the method 2-2 as an example, the embodiment of the disclosure is not limited thereto. That is, the UE may select either the method 2-1 or the method 2-2 based on other parameters.

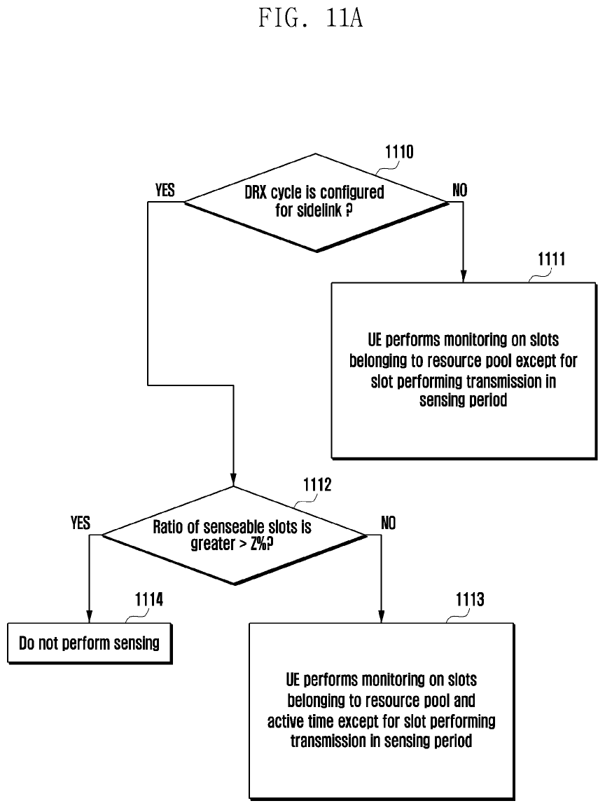

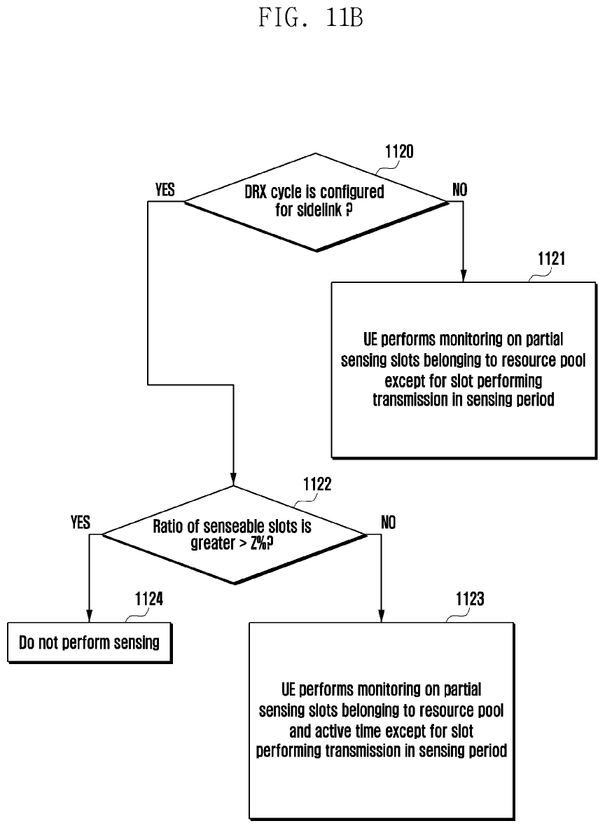

FIG. 11A is a flowchart illustrating a sensing procedure of the case that full sensing is performed according to a method 2-3 of the disclosure.

With reference to FIG. 11A, the UE may determine whether a DRX cycle is configured for a sidelink in step 1110. In the case that a DRX cycle is not configured, the UE performs a general full sensing operation in the sensing window in step 1111.

In the case that a DRX cycle is configured, the UE may calculate a ratio of senseable slots in the sensing window according to the proposed method in step 1112. Alternatively, according to another embodiment of the disclosure, step 1112 may be changed to a step of determining a parameter for selecting a method 2-1 or a method 2-2.

If it is determined that the determined ratio (or parameter) is capable of sensing (or if it is determined that the sensing result may be used), the UE performs sensing in a period configured to DRX on-duration (or active time) in step 1113.

If it is determined that it is impossible to perform sensing with the corresponding ratio in step 1112, the UE does not perform sensing in step 1114.

FIG. 11B is a flowchart illustrating a sensing procedure of the case that partial sensing is performed according to a method 2-3 of the disclosure.

With reference to FIG. 11B, the UE determines whether a DRX cycle is configured for a sidelink in step 1120. In the case that a DRX cycle is not configured, the UE performs a general partial sensing operation in the sensing window in step 1121.

In the case that a DRX cycle is configured, the UE may calculate a ratio of senseable slots in the sensing window according to the proposed method in step 1122. Alternatively, according to another embodiment of the disclosure, step 1122 may be changed to step of determining a parameter for selecting the method 2-1 or the method 2-2.

If it is determined that it is possible to perform sensing with the determined ratio (or parameter) (or if it is determined that the sensing result may be used), the UE performs sensing in a period configured to DRX on-duration (or active time) in step 1123.

If it is determined that it is impossible to perform sensing with the corresponding ratio in step 1122, the UE does not perform sensing in step 1124.

Hereinafter, the following method 2-4 may be considered as a sensing method when performing DRX.

### Method 2-4

In the case that a DRX cycle is configured for a sidelink, and in the case that a period in which sensing is not performed occurs due to DRX off-duration, the UE may extend the sensing window further than the already configured T0 to monitor slots belonging to DRX on-durations 1 and 2.

In the method 2-4, the sensing window may be extended so that an actual sensing time becomes Te. Here, Te may be determined to ensure the same sensing window on the assumption that DRX off-duration does not occur in the previously configured sensing window [n−T0, n−Tproc,0] or may be configured to a smaller value. That is, in the disclosure, a value of configurable Te is not limited to a specific value. Alternatively, the value Te may be predetermined, may be selected from predetermined candidate values, or may be selected by the UE implementation within a predetermined range. Alternatively, the value Te may be configured by the base station. In the above method, ‘the case that a DRX cycle is configured for a sidelink’ may be interpreted as ‘the case that DRX is performed in a sidelink’. The method 2-4 may be applied to both when performing full sensing and when performing partial sensing.

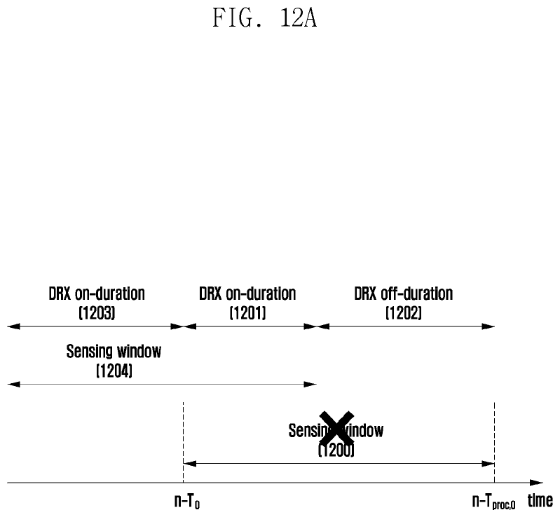

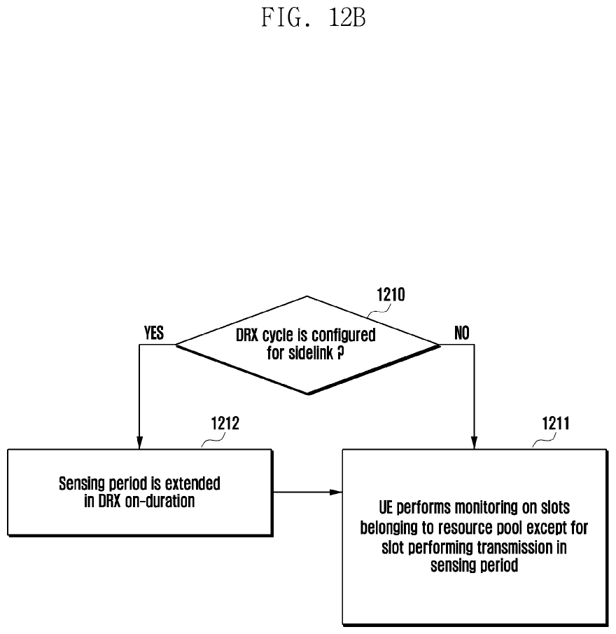

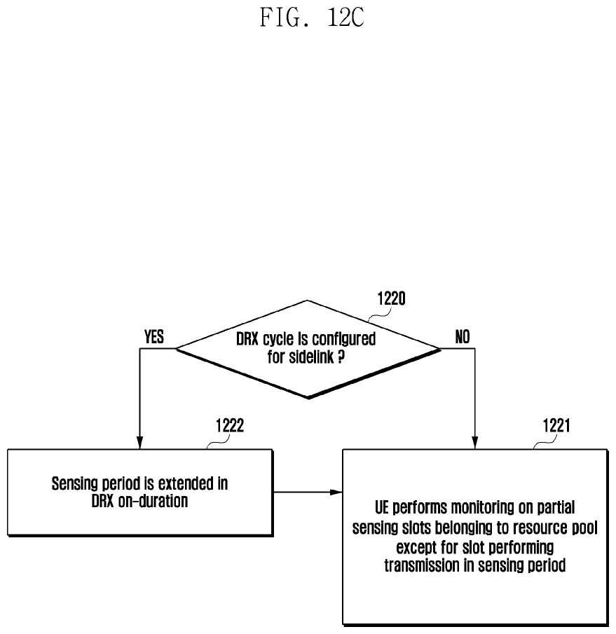

FIG. 12A is a diagram illustrating the method 2-4 according to an embodiment of the disclosure.

With reference to FIG. 12A, according to an embodiment of the disclosure, the case that a sensing window is extended further than a previously configured sensing window is illustrated.

According to the method 2-4, extension of the sensing window is possible only in a period configured to DRX on-duration (or active time). FIG. 12A illustrates the case that a sensing window 1200 is configured to [n−T0, n−Tproc,0] and that a part of the sensing window is configured to DRX on-duration 1201 and that a part of another sensing window is configured to DRX off-duration 1202.

FIG. 12A illustrates an example of DRX on-duration and off-duration, and DRX on-duration and off-duration may be generated in various ways according to DRX parameters. In the above method, DRX on-duration may be assumed to a period including both DRX on-durations 1 and 2. Details of the DRX on-durations 1 and 2 refer to the above description. According to the proposed method, because a part of the sensing window 1200 in FIG. 12A is configured to DRX off-duration 1202, sensing cannot be performed in the corresponding period; thus, the sensing window may be extended as in 1204 so as to further ensure the sensing window. In this case, the extended period may be made in DRX on-duration 1203. In the case that DRX on-duration is discontinuous, the sensing window may also be discontinuously generated.

FIG. 12B is a flowchart illustrating a sensing procedure of the case that full sensing is performed according to a method 2-4 of the disclosure.

With reference to FIG. 12B, the UE determines whether a DRX cycle is configured for a sidelink in step 1210. In the case that a DRX cycle is not configured, the UE performs a general full sensing operation in the sensing window in step 1211.

In the case that a DRX cycle is configured, the UE may determine so that the sensing window is extended from DRX on-duration (or active time) according to the proposed method in step 1212, and perform a full sensing operation in the corresponding sensing window in step 1211.

As described above, in order to perform step 1212, the UE may identify whether a part of the sensing window is off-duration, and in the case that a part of the sensing window is off-duration, the UE may perform step 1212.

FIG. 12C is a flowchart illustrating a sensing procedure of the case that partial sensing is performed according to a method 2-4 of the disclosure.

With reference to FIG. 12C, the UE determines whether a DRX cycle is configured for a sidelink in step 1220. In the case that a DRX cycle is not configured, the UE performs a general partial sensing operation in the sensing window in step 1221.

In the case that a DRX cycle is configured, the UE may determine so that a sensing window is extended from DRX on-duration (or active time) according to the proposed method in step 1222, and perform a partial sensing operation in the corresponding sensing window in step 1221.

As described above, in order to perform step 1222, the UE may identify whether a part of the sensing window is off-duration, and in the case that a part of the sensing window is off-duration, the UE may perform step 1222.

### Third Embodiment

In the third embodiment, details of the case of using the method 3 as a sensing method when performing DRX are presented. The method 3 is a method of defining the sensing window to DRX on-duration (or active time). The method proposed in this embodiment may be applied to both full sensing and partial sensing of a UE, as described in the second embodiment. Specifically, the following method 3 may be considered as a sensing method e performing DRX.

### Method 3

In the case that a DRX cycle is configured for a sidelink, on-duration (or active time) may include the following.
   When a drx-onDurationTimer, a drx-InactivityTimer, or a drx-RetransmissionTimer operates; or
   When sensing is performed in the sensing window

In the above method, ‘the case that a DRX cycle is configured for a sidelink’ may be interpreted as ‘the case that DRX is performed in a sidelink’. The case of the method 3 may be applied to both when performing full sensing and when performing partial sensing.

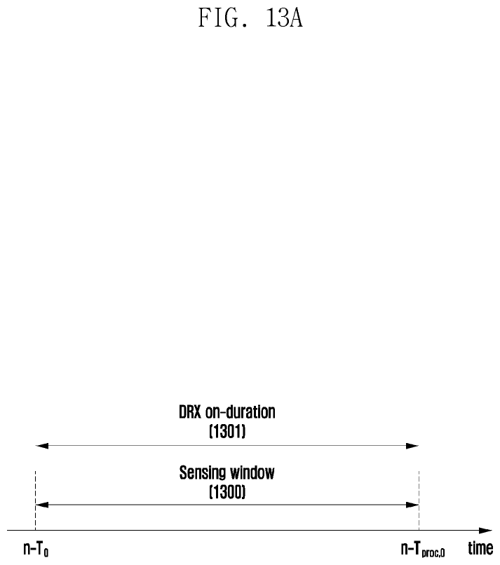

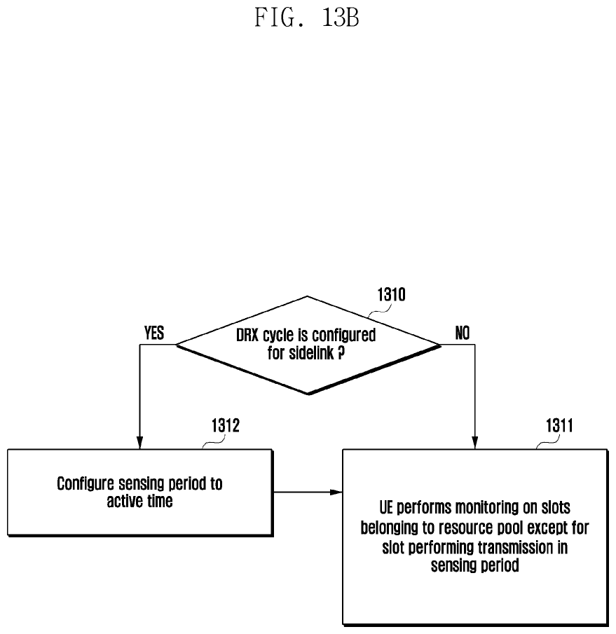

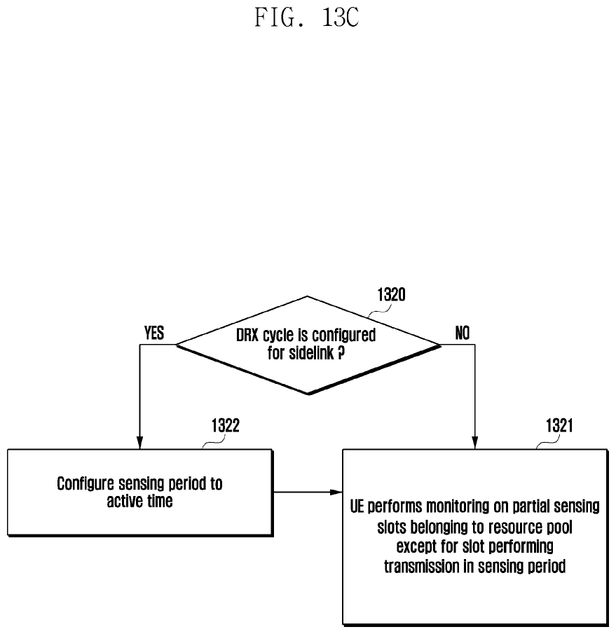

FIG. 13A is a diagram illustrating the method 3 according to an embodiment of the disclosure.

With reference to FIG. 13A, in the case that a DRX cycle is configured for a sidelink according to an embodiment of the disclosure, a method in which a sensing window is defined to DRX on-duration (or active time) is illustrated.

In FIG. 13A, in the case that a sensing window 1300 is configured to [n−T0, n-Tproc,0] and that the UE performs sensing in the corresponding period, all the sensing window 1300 is configured to DRX on-duration (or active time), as in 1301. According to the method 3, the UE may wake up in the sensing window and receive control information to perform sensing regardless of how a part of the sensing window is configured to off-duration.

FIG. 13B is a flowchart illustrating a sensing procedure of the case that full sensing is performed according to a method 3 of the disclosure.

With reference to FIG. 13B, in step 1310, the UE determines whether a DRX cycle is configured for a sidelink. In the case that a DRX cycle is not configured, the UE may perform a general full sensing operation within the sensing window in step 1311.

In the case that a DRX cycle is configured, the sensing window is configured to DRX on-duration (or active time) according to the proposed method in step 1312, and the UE may perform a full sensing operation in the corresponding sensing window in step 1311.

FIG. 13C is a flowchart illustrating a sensing procedure of the case that partial sensing is performed according to a method 3 of the disclosure.

With reference to FIG. 13C, the UE determines whether a DRX cycle is configured for a sidelink in step 1320. In the case that a DRX cycle is not configured, the UE may perform a general partial sensing operation in the sensing window in step 1321.

In the case that a DRX cycle is configured, the sensing window is configured to DRX on-duration (or active time) according to the proposed method in step 1322, and the UE may perform partial sensing operation in the corresponding sensing window in step 1321.

### Fourth Embodiment

In the fourth embodiment, details of the case of using the method 2 as a resource selection method when performing DRX are proposed. The method 2 is a method of performing resource selection in a period configured to DRX on-duration (or active time). First, the following method 4-1 may be considered to a resource selection method when performing DRX.

### Method 4-4

In the case that a DRX cycle is configured for a sidelink, the UE identifies candidate resources using a sensing result among resource candidates belonging to DRX on-duration 1 in a resource selection period. The UE may randomly select a (re)transmission resource among the identified candidate resources.

In the above method, ‘the case that a DRX cycle is configured for a sidelink’ may be interpreted as ‘the case that DRX is performed in a sidelink’. As described above, an operation of considering resource selection in DRX on-duration 1 during a DRX operation may be a particularly effective operation in unicast. This is because resource reception of other UEs may be ensured in the corresponding period when a resource is selected in consideration of DRX on-duration (or active time) between UEs performing sidelink communication using unicast. However, this embodiment may also be applied to groupcast and broadcast.

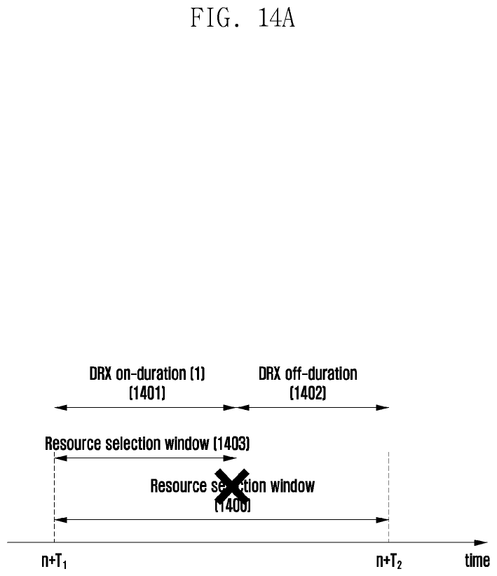

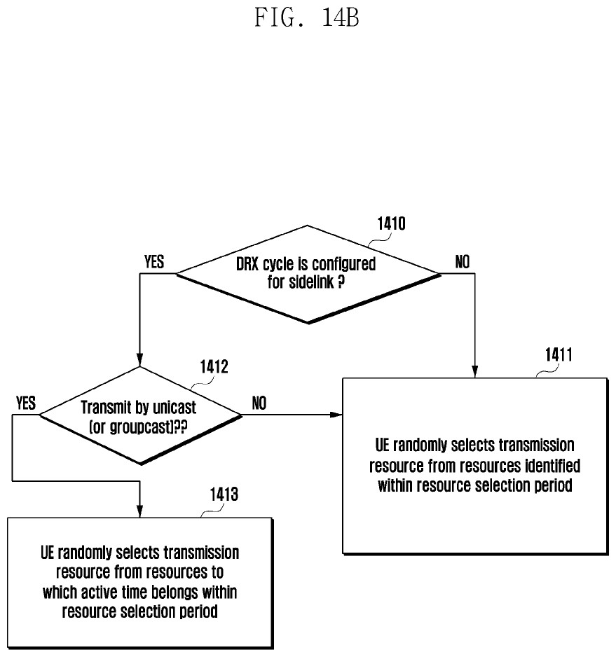

FIG. 14A is a diagram illustrating the method 4-1 according to an embodiment of the disclosure.

With reference to FIG. 14A, according to an embodiment of the disclosure, the case that a resource selection period is adjusted to a period configured to DRX on-duration (or active time) is illustrated. FIG. 14A illustrates the case that a resource selection period 1400 is configured to [n+T1, n+T2] and that a part of the resource selection period is configured to DRX on-duration 1401 and that a part of another resource selection period is configured to DRX off-duration 1402.

FIG. 14A illustrates an example of DRX on-duration and off-duration, and it is noted that DRX on-duration and off-duration may be generated in various ways according to DRX parameters. In the above method, DRX on-duration period 1401 may be assumed to a period in which only DRX on-duration 1 is considered. Details of the DRX on-duration 1 refer to the above description. According to the proposed method, the resource selection period may be redefined, as illustrated in 1403 within the DRX on-duration period 1401 in FIG. 14A. In the case that DRX on-duration is discontinuous within the resource selection period, the resource selection period may also be discontinuously generated.

FIG. 14B is a flowchart illustrating a resource selection procedure according to a method 4-1 of the disclosure.

With reference to FIG. 14B, the UE determines whether a DRX cycle is configured for a sidelink in step 1410. In the case that a DRX cycle is not configured, the UE may perform a general resource selection operation in the resource selection period in step 1411.

In the case that a DRX cycle is configured, the UE may perform an operation of identifying a transmission method in step 1412. In step 1412, only in the case that the transmission method is unicast or groupcast, the method proposed in step 1413 is applied, otherwise, a general resource selection operation is performed within the resource selection period in step 1411.

However, step 1412 may be omitted. The case in which step 1412 is omitted is the case that the above proposed method is equally applied to all transmission methods of unicast, groupcast, and broadcast, and in this case, in the case that a DRX cycle is configured in step 1410, the UE may perform step 1413.

Hereinafter, the following method 4-2 may be considered as a resource selection method when performing DRX.

### Method 4-2

In the case that a DRX cycle is configured for a sidelink, the UE may extend the resource selection period further than the previously configured T2 in the case that resource selection is not performed in DRX off-duration, and identify candidate resources using the sensing result among resource candidates belonging to DRX on-duration 1. The UE may randomly select a (re)transmission resource among the identified candidate resources.

In the case of extending the resource selection period in the above method, the resource selection period may be extended to satisfy a packet delay budget (PDB) for resource transmission. That is, the resource selection period may be extended to satisfy delay requirements for resource transmission.

In the above method, ‘the case that a DRX cycle is configured for a sidelink’ may be interpreted as ‘the case that DRX is performed in a sidelink’. As described above, an operation of considering resource selection in DRX on-duration 1 during a DRX operation may be a particularly effective operation in unicast. This is because resource reception of other UEs may be ensured in the corresponding period when a resource is selected in consideration of DRX on-duration (or active time) between UEs performing sidelink communication using unicast. However, this embodiment may also be applied to groupcast and broadcast.

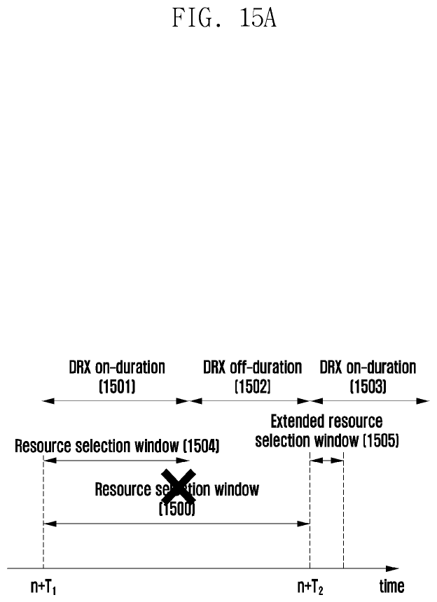

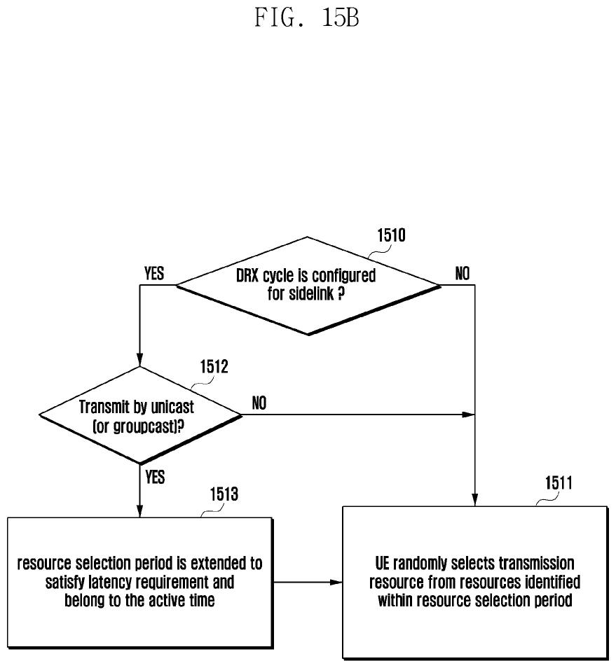

FIG. 15A is a diagram illustrating the method 4-2 according to an embodiment of the disclosure.

With reference to FIG. 15A, according to an embodiment of the disclosure, the case that a resource selection period is extended further than a previously configured sensing window is illustrated. According to the method 4-2, the extension of the resource selection period is possible only in a period configured to DRX on-duration 1 (or active time). Further, the resource selection period may be extended within a range satisfying a PDB. Specifically, FIG. 15A illustrates the case that a resource selection period 1500 is configured to [n+T1, n+T2], and that a part of the resource selection period is configured to DRX on-duration 1501, and that a part of another resource selection period is configured to DRX off-duration 1502.

FIG. 15A illustrates an example of DRX on-duration and off-duration, and it is noted that DRX on-duration and off-duration may be generated in various ways according to DRX parameters. In the above method, DRX on-duration 1501 may be assumed to a period in which only DRX on-duration 1 is considered. Details of the DRX on-duration 1 refer to the above description. According to the proposed method, in FIG. 15A, a resource selection period may be redefined, as in 1504 in the DRX on-duration period 1501. Further, as in 1505, the resource selection period may be extended further than T2. In the case that DRX on-duration is discontinuous, the resource selection period may also be discontinuously generated.

FIG. 15B is a flowchart illustrating a resource selection procedure according to a method 4-2 of the disclosure.

With reference to FIG. 15B, the UE determines whether a DRX cycle is configured for a sidelink in step 1510. In the case that a DRX cycle is not configured, the UE may perform a general resource selection operation in the resource selection period in step 1511.

In the case that a DRX cycle is configured, the UE may perform an operation of identifying a transmission method in step 1512. In step 1512, only in the case that the transmission method is unicast or groupcast, the method proposed in step 1513 is applied, otherwise, a general resource selection operation is performed within the resource selection period in step 1511.

However, step 1512 may be omitted. The case that step 1512 is omitted is the case that the above proposed method is equally applied to all transmission methods of unicast, groupcast, and broadcast, and in this case, in the case that a DRX cycle is configured in step 1510, the UE may perform step 1513.

### Fifth Embodiment

In the fifth embodiment, details of the case of using the method 3 as a resource selection method when performing DRX are presented. The method 3 is a method of defining the resource selection period to DRX on-duration (or active time) Specifically, the follow method 5 may be considered as a resource selection method when performing DRX.

### Method 5

In the case that a DRX cycle is configured for a sidelink, on-duration (or active time) may include the following.
   When a drx-onDurationTimer, a drx-InactivityTimer, or a drx-RetransmissionTimer operates; or
   When resource selection is performed in the resource selection window

In the above method, ‘the case that a DRX cycle is configured for a sidelink’ may be interpreted as ‘the case that DRX is performed in a sidelink’.

In the case that the method 5 is applied, the UE needs to indicate the corresponding information to another UE. Specifically, information on DRX on-duration (or active time) determined by the method 5 (which may be interpreted as information on the resource selection period of the corresponding UE) may be indicated to another UE. This is to enable reception of corresponding transmission by another UE awakened in the corresponding period when the transmitting UE selects and transmits a resource in the corresponding period. Corresponding information may be indicated through L1 signaling, and in this case, 1st SCI and 2nd SCI may be used. Further, in the case that a WUS is introduced, a method of including the corresponding information in the WUS may be considered. The UE that has received the corresponding information through L1 signaling may identify DRX on-duration (or active time) determined by the method 5 and wake up in the corresponding period to receive control information and data information.

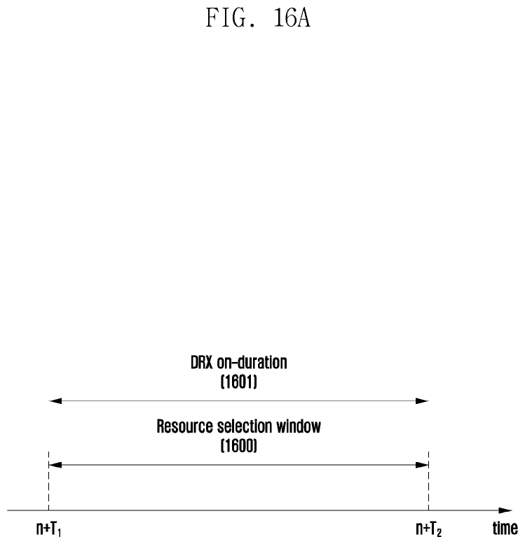

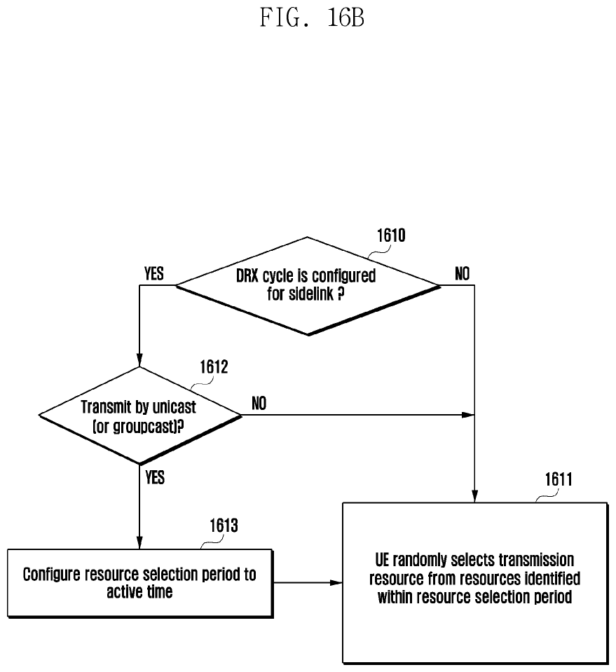

FIG. 16A is a diagram illustrating the method 5 according to an embodiment of the disclosure.

With reference to FIG. 16A, in the case that a DRX cycle is configured for a sidelink according to an embodiment of the disclosure, a method in which a resource selection period is defined to DRX on-duration (or active time) is illustrated. In FIG. 16A, in the case that a resource selection period 1600 is configured to [n+T1, n+T2] and that the UE performs resource selection in the corresponding period, all the resource selection period 1600 may be configured to DRX on-duration (or active time), as in 1601. According to the method 5, a period for performing resource selection is configured to DRX on-duration (or active time), regardless of how a part of the resource selection period is configured to off-duration, and the corresponding information is directed to another UE; thus, the another UE may wake-up in the corresponding period to receive control information.

FIG. 16B is a diagram illustrating a resource selection procedure according to a method 5 of the disclosure.

With reference to FIG. 16B, in step 1610, the UE may determine whether a DRX cycle is configured for a sidelink.

In the case that a DRX cycle is not configured, the UE may perform a general resource selection operation within the resource selection period in step 1611.

In the case that a DRX cycle is configured, the UE may perform an operation of identifying a transmission method in step 1612. In step 1612, the proposed method in step 1613 is applied only in the case that the transmission method is unicast or groupcast, otherwise, in step 1611, a general resource selection operation is performed within the resource selection period.

However, step 1612 may be omitted. The case in which step 1612 is omitted is the case that the above proposed method is equally applied to all transmission methods of unicast, groupcast, and broadcast, and in the case that a DRX cycle is configured for step 1610, the UE may perform step 1613.

In the drawings illustrating the method of the disclosure, the order of description does not necessarily correspond to the order of execution, and the precedence relationship may be changed or may be executed in parallel.

Alternatively, the drawings illustrating the method of the disclosure may omit some components and include only some components within a range that does not impair the essence of the disclosure.

Further, the method of the disclosure may be implemented in a combination of some or all of contents included in each embodiment within a range that does not impair the essence of the disclosure. That is, methods 1 to 5 described in the disclosure may be combined in part or in whole within a range that does not include the essence of the disclosure.

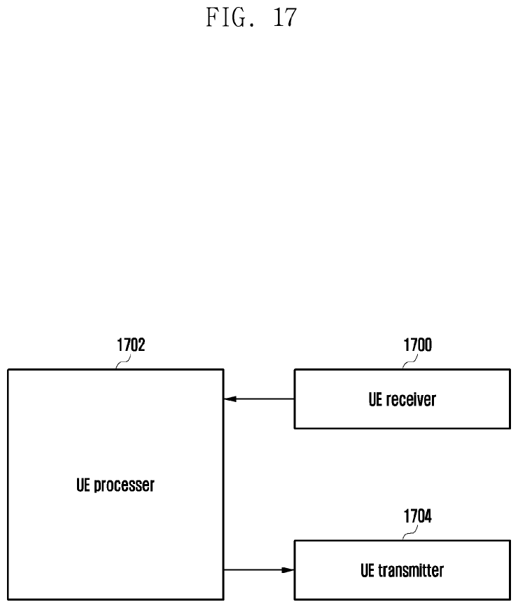

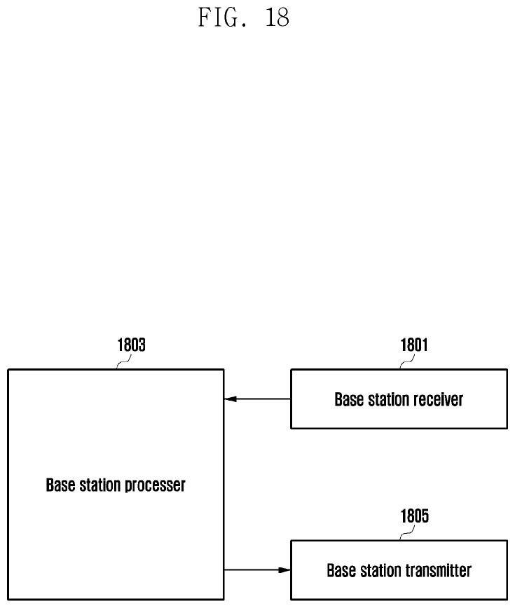

In order to perform the above embodiments of the disclosure, a transmitter, a receiver, and a processor of the UE and the base station are illustrated in FIGS. 17 and 18, respectively. In the above embodiments, a method for performing sensing and resource selection when the UE performs DRX in a sidelink is illustrated, and in order to perform this, the receiver, the processer, and the transmitter of the base station and the UE should operate according to the embodiment, respectively.

Specifically, FIG. 17 is a block diagram illustrating an internal structure of a UE according to an embodiment of the disclosure. As illustrated in FIG. 17, the UE of the disclosure may include a UE receiver 1700, a UE transmitter 1704, and a UE processer 1702. The UE receiver 1700 and the UE transmitter 1704 may collectively refer to as a transceiver in an embodiment of the disclosure. The transceiver may transmit and receive a signal to and from the base station. The signal may include control information and data. To this end, the transceiver may include an RF transmitter for up-converting and amplifying a frequency of a signal to be transmitted, and an RF receiver for low-noise amplifying a received signal and down-converting a frequency of the received signal. Further, the transceiver may receive a signal through a wireless channel and output the signal to the UE processer 1702, and transmit the signal output from the UE processer 1702 through the wireless channel. The UE processer 1702 may control a series of processes so that the UE may operate according to the above-described embodiment of the disclosure.

FIG. 18 is a block diagram illustrating an internal structure of a base station according to an embodiment of the disclosure. As illustrated in FIG. 18, the base station of the disclosure may include a base station receiver 1801, a base station transmitter 1805, and a base station processer 1803. The base station receiver 1801 and the base station transmitter 1805 may be collectively referred to as a transceiver in an embodiment of the disclosure. The transceiver may transmit and receive a signal to and from the UE. The signal may include control information and data. To this end, the transceiver may include an RF transmitter for up-converting and amplifying a frequency of a signal to be transmitted, and an RF receiver for low-noise amplifying a received signal and down-converting a frequency of the received signal. Further, the transceiver may receive a signal through a wireless channel and output the signal to the base station processer 1803, and transmit the signal output from the UE processer 1803 through the wireless channel. The base station processer 1803 may control a series of processes so that the base station may operate according to the above-described embodiment of the disclosure.

Embodiments of the disclosure disclosed in this specification and drawings present specific examples to easily describe the technical content of the disclosure and to help the understanding of the disclosure, and are not intended to limit the scope of the disclosure. That is, it is apparent to those of ordinary skill in the art that other modifications based on the technical spirit of the disclosure may be implemented. Further, each of the above embodiments may be operated in combination with each other, as needed. For example, in all embodiments of the disclosure, parts may be combined with each other to operate a base station and a UE.

1-14. (canceled)

15. A method performed by a terminal in a communication system, the method comprising:
receiving, from a base station, a configuration including a sidelink discontinuous reception (DRX) configuration;
monitoring slots belonging to a sidelink resource pool within a sensing window; and
selecting a candidate resource based on a selection window within a sidelink DRX active time that is determined based on the sidelink DRX configuration.

16. The method of claim 15, wherein the sidelink DRX configuration includes a parameter for a sidelink DRX onduration timer and a parameter for a sidelink inactivity timer.

17. The method of claim 16, wherein the sidelink DRX active time includes time while the sidelink DRX onduration timer or the sidelink inactivity timer is running.

18. The method of claim 15, wherein the configuration includes a parameter indicates a start of the sensing window.

19. The method of claim 15, wherein the configuration includes information associated with the selection window, and
wherein the selection window is associated with a subcarrier spacing.

20. The method of claim 15, wherein end of the selection window is determined based on a remaining packet delay budget and the information associated with the selection window.

21. A terminal in a communication system, the terminal comprising:
a transceiver; and
a controller coupled with the transceiver and configured to:
receive, from a base station, a configuration including a sidelink discontinuous reception (DRX) configuration,
monitor slots belonging to a sidelink resource pool within a sensing window, and
select a candidate resource based on a selection window within a sidelink DRX active time that is determined based on the sidelink DRX configuration.

22. The terminal of claim 21, wherein the sidelink DRX configuration includes a parameter for a sidelink DRX onduration timer and a parameter for a sidelink inactivity timer.

23. The terminal of claim 22, wherein the sidelink DRX active time includes time while the sidelink DRX onduration timer or the sidelink inactivity timer is running.

24. The terminal of claim 21, wherein the configuration includes a parameter indicates a start of the sensing window.

25. The terminal of claim 21, wherein the configuration includes information associated with the selection window, and
wherein the selection window is associated with a subcarrier spacing.

26. The terminal of claim 21, wherein end of the selection window is determined based on a remaining packet delay budget and the information associated with the selection window.
